(19) United States
(12) Patent Application Publication
(10) Pub. No.: US 2016/0117466 A1
(43) Pub. Date: Apr. 28, 2016

(54) SYSTEM AND METHOD FOR RISK MANAGEMENT

(71) Applicant: Jay P. Singh, Great Falls, VA (US)

(72) Inventor: Jay P. Singh, Great Falls, VA (US)

(21) Appl. No.: 14/634,097

(22) Filed: Feb. 27, 2015

Related U.S. Application Data
(60) Provisional application No. 62/068,993, filed on Oct. 27, 2014.

(51) Int. Cl. G06F 19/00; G06Q 50/26

(52) U.S. Cl. CPC G06F 19/3431; G06Q 50/265

(57) ABSTRACT

This disclosure relates generally to methods and systems adapted for risk management. The system includes a processor and an analytics module. The analytics module is configured to receive, at the processor, a first result associated with a first behavior outcome based on first information related to an evaluee, second information related to a set of one or more people, and third information related to the evaluee different from the first information. The analytics module is configured to execute instructions, by the processor, to perform analytics to determine a second result associated with a second behavior outcome of the evaluee relative to the set of one or more people, based on at least the third information.

### CROSS-REFERENCE TO RELATED APPLICATIONS

This application claims priority of U.S. Provisional Application No. 62/068,993 filed on Oct. 27, 2014 the entire contents of which are incorporated herein by reference.

### TECHNICAL FIELD

The present disclosure relates generally to systems and methods for risk management. Particularly, the disclosure is direct to systems and methods for risk assessment, management, monitoring, prediction, formulation, and reduction related to various contexts including, for example, mental health, criminal justice, legal, education, and workplace.

### BACKGROUND

Establishing valid and reliable methods and systems for identifying individuals who are likely to engage in adverse behavioral outcomes is an important public health and safety issue. One method of identifying such individuals is through the use of a risk assessment tool, which is a structured instrument designed to predict the likelihood, imminence, severity, frequency, or a likely victim of adverse behavior.

### SUMMARY

The present disclosure relates generally to systems, methods, medium, and other implementations directed to risk management for risk management. Particularly, the disclosure is direct to systems, methods, medium, and other implementations for risk assessment, management, monitoring, prediction, formulation, and reduction related to various contexts including, for example, mental health, criminal justice, legal, education, and workplace. For brevity, “risk management” as used herein may include risk assessment, monitoring, prediction, formulation, reduction, or the like, or a combination thereof.

In an example, a system including an analytics module is provided. The system is adapted for risk management. The analytics module is configured to receive, at a processor, a first result associated with a first behavior outcome based on first information related to an evaluee, second information related to a set of one or more people, and third information related to the evaluee different from the first information. The analytics module is configured to execute instructions, by the processor, to perform analytics to determine a second result associated with a second behavior outcome of the evaluee relative to the set of one or more people, based on at least the third information related to the evaluee that is different from the first information. The first information, the second information, or the third information may relate to a criminal history, a sociodemographic characteristic, a clinical characteristic, a physiological or biological characteristic, a sociological characteristic, a behavioral characteristic, or a psychological characteristic, or a change thereof, of the evaluee or the set of one or more people. In some embodiments, the analytics module includes an analytics controller and an analytics processor. The analytics controller is configured to execute the instructions, by the processor, to select the analytics to be performed based on at least the first result associated with a first behavior outcome related to the evaluee or the second information related to the set of one or more people. The analytics processor is configured to execute the instructions, by the processor, to perform the analytics to determine the second result, based on the selected analytics, the second result associated with the second behavior outcome of the evaluee relative to the set of one or more people based on, e.g., the first information related to the evaluee, the first result associated with a first behavior outcome related to the evaluee, the second information related to the set of one or more people, or the third information related to the evaluee that is different from the first information, or the like, or a combination thereof. The analytics module may further include at least one of an information processor, an analytics monitoring unit, a reliability assessment unit, a compliance unit, or the like, or a combination thereof. The system may further include at least one of a signup module, an authentication module, a tool selection module, an assessment module, a reporting module, a tool library maintenance module, a tool development module, or an analytics database maintenance module, or the like, or a combination thereof. The system may further include at least one of a user information database, a tool library, or an analytics database, or the like, or a combination thereof.

In another example, a method including a series of actions is provided. The method includes receiving at a processor a first result associated with a first behavior outcome based on first information related to an evaluee, second information related to a set of one or more people, and third information related to the evaluee different from the first information. The method includes performing, by the processor, analytics to determine a second result associated with a second behavior outcome of the evaluee relative to the set of one or more people, based on at least the third information related to the evaluee that is different from the first information. The processor is adapted for risk management. The first information, the second information, or the third information may relate to a criminal history, a sociodemographic characteristic, a clinical characteristic, a physiological or biological characteristic, a sociological characteristic, a behavioral characteristic, or a psychological characteristic, or a change thereof, of the evaluee or the set of one or more people. In some embodiments, the method may further include selecting, by the processor, the analytics to be performed based on at least the first result associated with a first behavior outcome related to the evaluee or the second information related to the set of one or more people.

Other concepts relate to software for implementing the present teaching on risk management. A software product, in accord with this concept, includes at least one machine-readable non-transitory medium and information carried by the medium. The information carried by the medium may be executable program code data, parameters in association with the executable program code, and/or information related to a user, a request, content, or information related to an institution, etc.

In a different example, a non-transitory machine-readable tangible medium having instructions recorded thereon is provided. The recorded instructions, when read by the machine, cause the machine to perform a series of actions. Received at a process includes a first result associated with a first behavior outcome based on first information related to an evaluee, second information related to a set of one or more people, and third information related to the evaluee different from the first information. Analytics is performed, by the processor, to determine a second result associated with a second behavior outcome of the evaluee relative to the set of one or more people, based on at least the third information related to the evaluee. The processor is adapted for risk management. The first information, the second information, or the third information may relate to a criminal history, a sociodemographic characteristic, a clinical characteristic, a physiological or biological characteristic, a sociological characteristic, a behavioral characteristic, or a psychological characteristic, or a change thereof, of the evaluee or the set of one or more people. In some embodiments, the analytics to be performed is selected, based on at least the first result associated with a first behavior outcome related to the evaluee or the second information related to the set of one or more people.

In a different example, a non-transitory machine-readable tangible medium having instructions recorded thereon is provided related to the tool development module. The recorded instructions, when read by the machine, cause the machine to perform a series of actions for developing a risk assessment tool. First information is received. The first information relates to a criminal history, a sociodemographic characteristic, a clinical characteristic, a physiological or biological characteristic, a sociological characteristic, a behavioral characteristic, or a psychological characteristic, or a change thereof, of an evaluee. A first result associated with a first behavior outcome of the evaluee is received. Second information with respect to a set of one or more people is received. The second information relates to a criminal history, a sociodemographic characteristic, a clinical characteristic, a physiological or biological characteristic, a sociological characteristic, a behavioral characteristic, or a psychological characteristic, or a change thereof, of the set of one or more people. A second result associated with a second behavior outcome of the evaluee relative to the set of one or more people is determined based on the first information related to the evaluee, the first result associated with a first behavior outcome of the evaluee, or the second information related to the set of one or more people, or the like, or a combination thereof.

Additional features will be set forth in part in the description which follows, and in part will become apparent to those skilled in the art upon examination of the following and the accompanying drawings or may be learned by production or operation of the examples. The features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1 and 2 illustrate exemplary networked environments in which a risk management system may be deployed in accordance with various embodiments of the present teaching;

FIG. 3 illustrates an exemplary diagram of a risk management system of the networked environments shown in FIGS. 1 and 2, according to an embodiment of the present teaching;

FIG. 4 illustrates an exemplary screenshot including a risk management application that constitutes a user interface of a risk management system according to an embodiment of the present teaching;

FIG. 5 illustrates an exemplary diagram of a signup module according to an embodiment of the present teaching;

FIG. 6 illustrates a flowchart of an exemplary signup process according to an embodiment of the present teaching;

FIG. 7 illustrates an exemplary page where a signup process may be initiated in a risk management application that constitutes a user interface of a risk management system according to an embodiment of the present teaching;

FIG. 8 illustrates an exemplary diagram of an authentication module according to an embodiment of the present teaching;

FIG. 9 illustrates a flowchart of an exemplary authentication process according to an embodiment of the present teaching;

FIG. 10 illustrates an exemplary authentication page in a risk management application that constitutes a user interface of a risk management system according to an embodiment of the present teaching;

FIG. 11 illustrates a page providing exemplary options available to a user (e.g., evaluator) in a risk management application that constitutes a user interface of a risk management system according to an embodiment of the present teaching;

FIG. 12 illustrates an exemplary diagram of a tool selection module according to an embodiment of the present teaching;

FIG. 13 illustrates a flowchart of an exemplary tool selection process according to an embodiment of the present teaching;

FIG. 14 illustrates exemplary types of risk assessment in a risk management system according to an embodiment of the present teaching;

FIG. 15 illustrates an exemplary tool selection page in a risk management application that constitutes a user interface of a risk management system according to an embodiment of the present teaching;

FIG. 16 illustrates a page displaying the acronyms and full names of risk assessment tools in a risk management system according to an embodiment of the present teaching;

FIG. 17 illustrates an exemplary diagram of a tool library maintenance module according to an embodiment of the present teaching;

FIG. 18 illustrates a flowchart of an exemplary process of maintaining a tool library according to an embodiment of the present teaching;

FIG. 19 illustrates an exemplary diagram of an assessment module according to an embodiment of the present teaching;

FIG. 20 illustrates a flowchart of an exemplary process of risk assessment according to an embodiment of the present teaching;

FIG. 21 illustrates an exemplary page showing coding sheets related to a user (e.g., evaluee) archived in a risk management system according to an embodiment of the present teaching;

FIG. 22 illustrates an exemplary page showing the option of overriding an assessment result in a risk management application that constitutes a user interface of a risk management system according to an embodiment of the present teaching;

FIG. 23 illustrates an exemplary page related to setting up a reminder for a re-assessment of a user (e.g., evaluee) in a risk management application that constitutes a user interface of a risk management system according to an embodiment of the present teaching;

FIG. 24 illustrates an exemplary page requesting information regarding a report and a user (e.g., evaluator) according to an embodiment of the present teaching;

FIG. 25 illustrates an exemplary page requesting user (e.g., evaluator) confirmation for submitting a form related to an assessment in a risk management application that constitutes a user interface of a risk management system according to an embodiment of the present teaching;

FIG. 26 illustrates a page providing exemplary options available to a user (e.g., evaluator) in a risk management application that constitutes a user interface of a risk management system according to an embodiment of the present teaching;

FIG. 27 illustrates an exemplary diagram of an analytics module according to an embodiment of the present teaching;

FIG. 28 illustrates a flowchart of an exemplary process of assessing inter-rater reliability according to an embodiment of the present teaching;

FIG. 29 illustrates an exemplary diagram of an information processor in the analytics module according to an embodiment of the present teaching;

FIG. 30 illustrates a flowchart of an exemplary process of performing analytics according to an embodiment of the present teaching;

FIGS. 31A-31E illustrate exemplary types and results of analytics that may be performed in a risk management system according to an embodiment of the present teaching;

FIG. 32 illustrates a page regarding preparation of a report in a risk management application that constitutes a user interface of a risk management system according to an embodiment of the present teaching;

FIG. 33 illustrates an exemplary diagram of an analytics database maintenance module according to an embodiment of the present teaching;

FIG. 34 illustrates a flowchart of an exemplary process of maintaining an analytics database according to an embodiment of the present teaching;

FIG. 35 illustrates an exemplary diagram of a reporting module according to an embodiment of the present teaching;

FIG. 36 illustrates a flowchart of an exemplary reporting process according to an embodiment of the present teaching;

FIG. 37 illustrates the architecture of a mobile device which may be used to implement a specialized system incorporating the present teaching; and

FIG. 38 illustrates the architecture of a computer which may be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present teaching describes systems, methods, medium, and other implementations directed to risk management. The systems, methods, medium, and other implementations, realized as a specialized and networked system by utilizing one or more computing devices (e.g., mobile phone, personal computer, etc.) and network communications (wired or wireless), relate to assessing, managing, monitoring, predicting, formulating, and reducing risk in the context of, e.g., mental health, criminal justice, educational institutions, and workplace. “Risk management” as used herein may include risk assessment, monitoring, prediction, formulation, reduction, or the like, or a combination thereof. In some embodiments, the method and system involve performing analytics with respect to an evaluee using information and/or result(s) based on a risk assessment of the evaluee, and information and/or result(s) from risk assessments of a set of one or more people. The set may include one or more people in the same or similar communities, one or more people from the same or similar institutions (e.g., prisons or jails, mental institutions, outpatient clinics, drug treatment centers, half-way houses, hospitals, schools or universities, etc.), workplaces, one or more people with the same or similar family background, diagnostic background, education background, and/or employment background, etc. The result from a risk assessment may be associated with a behavior outcome. The information may be related to, e.g., a criminal history, a sociodemographic characteristic, a clinical characteristic, a physiological or biological characteristic, a sociological characteristic, a behavioral characteristic, or a psychological characteristic, or a change thereof, of the evaluee or the set of one or more people. The analytics with respect to the evaluee may be performed based also on additional information related to the evaluee, from information sources approved by the evaluee, assessment information and/or assessment results with respect or related to the evaluee, external databases, or the like, or a combination thereof. Such sources may include, e.g., medical records, court records, police reports, institutional reports, attendance in therapeutic activities, evaluee-approved supply of biometric data through the use of personal smart devices or access to electronic health records, global positioning system (GPS) location data, prescription adherence platforms, unemployment benefit recipient database, social media, gun purchase databases, criminal record databases, etc. Additional information related to the evaluee may include, e.g., an event (e.g., unemployment, divorce, dropping out from school, etc.), a posting on a website (e.g., a social networking website), failure to participate in a rehabilitation program, failure to participate in a therapeutic activity, failure to take or refill a medication, failure to report to a caseworker or social worker, etc. In some embodiments, the method and system also involve performing a risk assessment for the evaluee based on or by weighing information related to, e.g., a criminal history, a sociodemographic characteristic, a clinical characteristic, a physiological or biological characteristic, a sociological characteristic, a behavioral characteristic, or a psychological characteristic, or a change thereof, of the evaluee. Various sources of data, information, or input may be used to improve the validity and/or reliability of predictions than produced by evaluator-administered risk assessment tools, and to monitor a change in the risk related to an evaluee over time, including between risk assessment sessions. Such improved risk assessment, management, monitoring, prediction, and formulation may allow timely intervention to reduce the risk related to the evaluee.

A risk management system or method disclosed herein may be used on a desktop computer, a laptop computer, a smartphone (e.g., iPhone), a tablet (e.g., iPad), a wearable device (e.g., eyeglasses (e.g., Google Glass), smartwatch), or the like. A risk management system or method disclosed herein may be used in, e.g., mental health, criminal justice, correctional, legal, workplace, and school settings, or the like, around the world. It may allow an user (e.g., evaluator, evaluee) to administer an instrument (e.g., a risk assessment tool) designed to predict, e.g., a result associated with, e.g., violence, sex offender recidivism, general recidivism, suicide, absconsion, unemployment, pretrial failure, terrorism, substance use, domestic violence, workplace violence, or the like, or a combination thereof. The prediction may take the form of, e.g., a categorical judgment (e.g., Low Risk, Moderate Risk, or High Risk), a probabilistic estimate within a specific timeframe (e.g., 10% within 10 years), a score between 0 to 100, etc. The prediction may be derived from the considerations of theoretically-derived and/or empirically-derived risk factors and/or protective factors. Some of the risk/protective factors may be static, and some of the risk/protective factors may be dynamic. Exemplary risk/protective factors include those related to, e.g., violence, sex offender recidivism, general recidivism, suicide, absconsion, unemployment, pretrial failure, terrorism, substance use, domestic violence, workplace violence, or the like, or a combination thereof. Such risk management information may be useful in various contexts including, e.g., the mental health context, the criminal justice context, the legal context, the educational context, and the workplace context, or the like, or a combination thereof. Examples include hospitals, outpatient clinics, substance abuse centers, drug treatment centers, private practice offices or companies, domestic violence shelters, Veterans Affairs sites, mental health offices at schools and military installations, prisons, jails, probation and parole boards, halfway houses, community corrections, privatized correctional facilities, sheriff stations, police stations, training academies, pretrial evaluation centers, schools, universities, public and private practice offices or companies, or the like.

As used herein, actuarial risk assessment refers to a mechanical approach to risk assessment in which a sample of offenders are scored on a series of items statistically associated with the risk of an adverse outcome in the sample upon whom an instrument (e.g., a risk assessment tool) was developed. The total score or the range of the total score (referred to as a “bin,” e.g., Low Risk, Moderate Risk, High Risk) may be cross-referenced with a statistical table that translates the score into an estimate of the risk of an adverse outcome during a specified time frame.

As used herein, structured professional judgment refers to a structured approach to risk assessment focused on creating an individualized and coherent risk formulation and a comprehensive risk management plan. An evaluator may estimate risk through the consideration of a list of factors that are empirically- and/or theoretically-associated with the outcome of interest with respect to an evaluee (e.g., an offender). Total scores are not used to make final judgments of risk. Instead, an evaluator may consider the relevance of one or more items to the evaluee, as well as whether there may be any case-specific factors not explicitly included in the list of factors. A final judgment of risk may be made using risk “categories” such as Low Risk, Moderate Risk, or High Risk.

As used herein, clinical override refers to an option on a risk assessment tool (e.g., an actuarial risk assessment tool) that allows an individual administering the tool (e.g., evaluator) to override the prediction of risk made by the tool. The evaluator may substitute the prediction of risk made by the tool with his own prediction.

As used herein, a static factor refers to a historical or otherwise unchangeable characteristic (e.g., history of antisocial behavior) that may help establish the level (e.g., an absolute or baseline level) of the risk of an adverse outcome.

As used herein, a dynamic factor refers to a changeable characteristic (e.g., substance abuse) that may establish a relative level of risk and help inform intervention; a dynamic factor may be either relatively stable, changing relatively slowly over time (e.g., antisocial cognition), or acute, changing more quickly over time (e.g., mood state).

As used herein, an evaluator refers to a user or an individual conducting the risk assessment.

As used herein, an evaluee refers to a user or an individual whose risk is being assessed.

As used herein, forensic refers to the application of a scientific method and/or technique to the investigation of adverse outcomes in mental health, correctional, or legal settings (e.g., harm to oneself or others, among other adverse outcomes).

As used herein, a risk factor refers to a characteristic of an individual (e.g., an evaluee) (e.g., physical health, mental health, attitudes), his physical and/or social environment (e.g., neighborhood, family, peers) or situation (e.g., living situation) that may be associated with an increase in the likelihood of an adverse outcome.

As used herein, a protective factor refers to a characteristic of an individual (e.g., an evaluee) (e.g., physical health, mental health, attitudes), his physical and/or social environment (e.g., neighborhood, family, peers) or situation (e.g., living situation) that may be associated with a decrease in the likelihood of an adverse outcome.

As used herein, recidivism refers to relapse into criminal behavior by an individual (e.g., an evaluee) who has previously been convicted of or engaged in one or more offenses.

As used herein, risk assessment refers to a process of estimating the likelihood an individual will engage in an adverse behavior. It may also encompass the estimated imminence, frequency, severity, and likely victim of that adverse behavior. Risk assessment may help identify those at higher risk and/or in greater need of intervention. Risk assessment may also assist in the identification of treatment targets and the development of risk management and treatment plans.

As used herein, a risk assessment tool refers to an instrument composed of empirically- and/or theoretically-based static and/or dynamic risk and/or protective factors used to aid in risk assessment, management, monitoring, prediction, formulation, and/or reduction.

Various features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

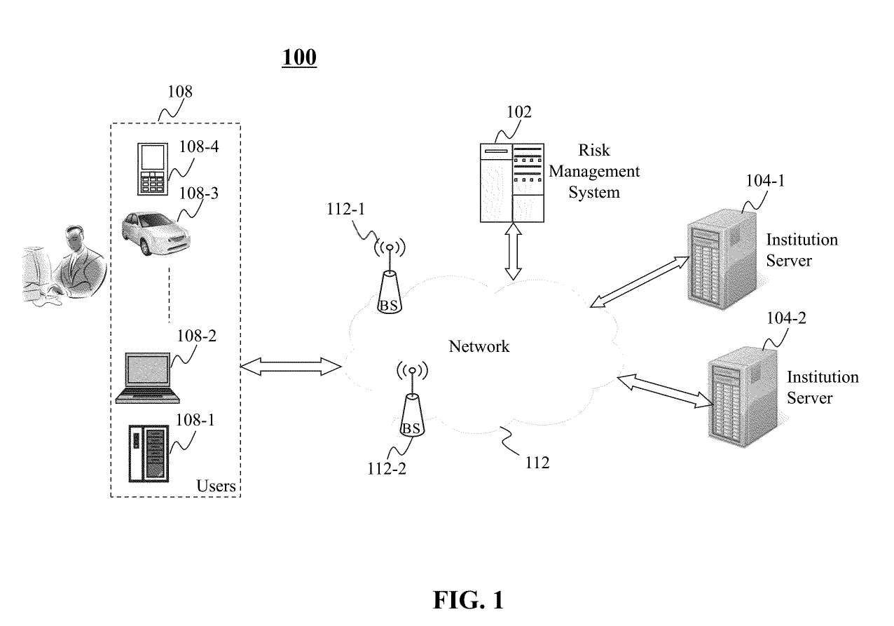

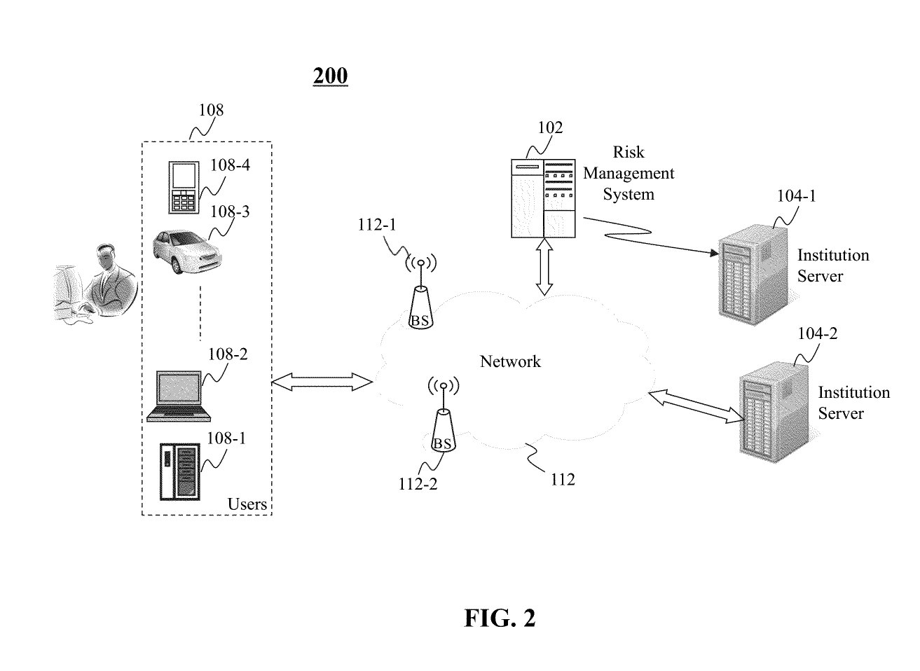

FIGS. 1 and 2 illustrate exemplary system configurations in which a risk management system 102 may be deployed in accordance with various embodiments of the present teaching. In FIG. 1, the exemplary networked environment 100 includes the risk management 102, one or more institution servers 104, one or more users 108, and a network 112.

The network 112 may be a single network or a combination of different networks. For example, the network 112 may be a local area network (LAN), a wide area network (WAN), a public network, a private network, a proprietary network, a Public Telephone Switched Network (PSTN), the Internet, a wireless network, a virtual network, or any combination thereof. The network 112 may also include various network access points, e.g., wired or wireless access points such as base stations or Internet exchange points 112-1, . . . , 112-2, through which a data source may connect to the network 112 in order to transmit information via the network 112.

Users 108 may be of different types such as users connected to the network 112 (or to the system disclosed herein, via a desktop computer 108-1, a laptop computer 108-2, a built-in device in a motor vehicle 108-3, or a smartphone 108-4 (e.g., iPhone). Users 108 may also be connected to the network 112 (or to the risk management system 102 disclosed herein) via, e.g., a tablet (e.g., iPad), or a wearable device (e.g., Google Glass, smartwatch). A user 108 may be an evaluee whose risk is assessed, managed, predicted, formulated, or monitored. A user 108 may be an evaluator who administers or conducts the risk assessment for an evaluee. The evaluator, as well as other people (e.g., a healthcare provider, a social worker, a probation or parole officer, a school counselor, a case manager, an employer of the evaluee, etc.), may also participate in, e.g., follow-up risk assessment, management, prediction, formulation, or monitoring of the evaluee. In some embodiments, the evaluator may be the evaluee (that is, the risk assessment is self-administered). A user 108 may be an institution (e.g., a hospital, a prison, a jail, an outpatient clinic, a drug treatment center, a half-way house, a mental institution, a school or university, a workplace, etc.), a professional or employee associated with the institution, a caseworker (or social worker) associated with the evaluee, police or a police officer, a community liaison, a tool developer who develops or is interested in developing a risk assessment tool, a family member, a friend, a likely victim, an employer, a colleague, or other people or parties that are associated with or related to the evaluee or interested in risk management with respect to the evaluee, or the like. Different users may have different access rights with respect to the risk management system 102, including access rights to data stored in or accessible from the risk management system 102. The access right of a user may be indicated or specified by way of, e.g., an identification factor that the user uses to log into the risk management system 102. As used herein, a risk may include likelihood, severity, imminence, frequency, a likely victim, or the like, or a combination thereof. The risk management system or method as disclosed herein may provide a result associated with a behavior outcome that indicates or relates to the risk associated with the behavior outcome.

An institution server 104, e.g., 104-1 or 104-2, may be, e.g., a server associated with the institution where information of patients, prisoners, employees, students, etc., are stored. The institution may be, e.g., a hospital, a prison, a jail, an outpatient clinic, a drug treatment center, a half-way house, a mental institution, a school or university, a workplace, etc. A user 108 or the risk management system 102 may access the institution servers 104 via the network 112. The risk management system 102 may serve multiple users 108 and/or multiple institution servers 104 via the network 112.

FIG. 2 is a high level depiction of another exemplary networked environment 200 in which the risk management 102 may be deployed in accordance with various embodiments of the present teaching. The networked environment 200 in this embodiment is similar to the networked environment 100 in FIG. 1, except that the institution server 104-1 is at the back end of the risk management system 102 in this embodiment, while the institution server 104-2 directly connects to the network 112.

In some embodiments, a user 108 may be embodied in an electronic, computing and communication hardware device of one of various forms. Such a device may be a mobile phone, a tablet computer, a personal computer, a server, a laptop, a smartphone, a gaming device, a networking device, or a wearable computing device (e.g., in the form of a wrist watch, a bracelet, a pair of headphones, a pair of eyeglasses, and/or other wearable computing devices). A user 108 may include one or more hardware, firmware, and/or software processor to implemented and execute various operations configured therein.

In some embodiments, a user 108 includes or uses a display device, an input device, an output device, a memory, a system-on-chip (SoC) chipset including a processor, a communication/network module, and an antenna. One or more of these devices may also include a bus and/or other interconnection means to connect and communicate information between various components or units of the one or more devices.

A display device may be configured to display information to a user 108. The display device may include a liquid crystal display (LCD), a light emitting diode (LED)-based display, or any other flat panel display or curved screen (or television), or may use a cathode ray tube (CRT).

An input device may include alphanumeric and other keys which may be inputted via a keyboard, touch screen (e.g., with haptics or tactile feedback), speech input, eye tracking input, a brain monitoring system, or other comparable input mechanism. The input information received through the input device may be communicated to a processor of the SoC, e.g., via a bus, for further processing. Another type of the input device may include a cursor control device, such as a mouse, a trackball, or cursor direction keys to communicate direction information and command selections, e.g., to the SoC and to control cursor movement on a display device.

A memory (or another part of the networked environment 100/200) may be a dynamic storage device configured to store information and instructions to be executed by the processor of the SoC and/or other processors (or computing units). The memory may also be used to store temporary variables or other intermediate information during execution of instructions by the processor(s). Part of or the entire memory may be implemented as Dual In-line Memory Modules (DIMMs), and may be one or more of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDECSRAM, PCIOO SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device. The memory may also include read-only memory (ROM) and/or another static storage device configured to store static information and instructions for the processor of the SoC and/or other processors (or computing units). Further, the memory may include a magnetic disk, optical disc or flash memory devices to store information and instructions.

The electronic storage media of any device of the networked environment 100/200 may include one or both of a system storage (e.g., a disk) that is provided integrally (i.e. substantially non-removable) with the device and/or removable storage that is removably connectable to the device via, for example, a port (e.g., a USB port, a firewire port, etc.) or a drive (e.g., a disk drive, etc. The electronic storage media of any device of the networked environment 100/200 may include or be connectively operational with one or more virtual storage resources (e.g., cloud storage, a virtual private network, and/or other virtual storage resources).

In some embodiments, the SoC is part of a core processing or computing unit of the device or system, and is configured to receive and process input data and instructions, provide output and/or control other components of the networked environment 100/200 in accordance with embodiments of the present teaching. In some embodiments, the SoC may include a microprocessor, a memory controller, a memory, and a peripheral component. The microprocessor may further include a cache memory (e.g., SRAM), which along with the memory of the SoC may be part of a memory hierarchy to store instructions and data. The microprocessor may also include one or more logic modules such as a field programmable gate array (FPGA) or other logic array. Communication between the SoC's microprocessor and memory may be facilitated by the memory controller (or chipset), which may also facilitate in communicating with the peripheral component, such as a counter-timer, a real-time timer, a power-on reset generator, or the like, or a combination thereof. The SoC may also include other components including, but not limited to, a timing source (e.g., an oscillator, a phase-locked loop, or the like), a voltage regulator, a power management circuit, or the like, or a combination thereof.

In some embodiments, different components of or related to the risk management system 102 (e.g., a user 108) may communicate with one another directly or via one or more networks through a communication platform. The communication platform may include appropriate and/or typical hardware, software and/or firmware modules, e.g., a modulator, a demodulator, a baseband converter, a channel codec, and/or other components, implemented therein to enable the device for wireless communication. As such, the communication platform may wirelessly transmit and receive data and messages in the form of radio frequency (RF) signals through an antenna. In some embodiments, the communication platform is designed and configured to support communication based on one or more current and future communication standards and protocols including, but not limited to, Wi-Fi, Wi-Gi, Bluetooth, GSM, CDMA, GPRS, 3G or 4G (e.g., WiMAX, LTE) cellular standards, Wireless USB, satellite communication, and Wireless LAN. Additionally or alternatively, the communication platform may also be configured for wired communication, e.g., based on the Ethernet standard, and as such, may be coupled to an appropriate network interface of the device.

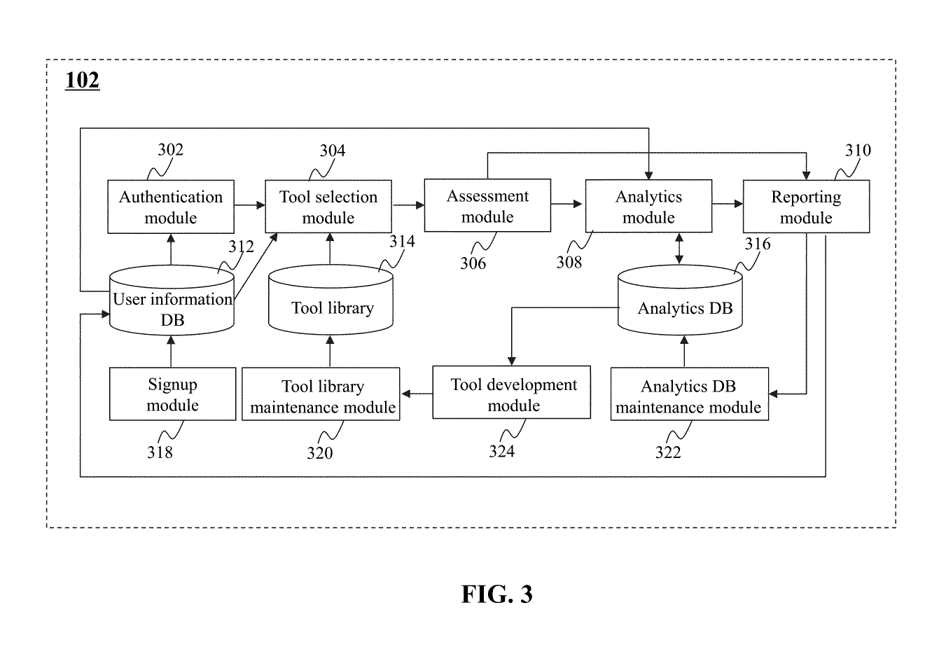

FIG. 3 illustrates an exemplary diagram of the risk management system 102 of the networked environments 100 and 200 shown in FIGS. 1 and 2, according to an embodiment of the present teaching. In this embodiment, the risk management system 102 includes an authentication module 302, a tool selection module 304, an assessment module 306, an analytics module 308, a reporting module 310, a signup module 318, a tool library maintenance module 320, an analytics maintenance module 322, a tool development module 324, a user information database (DB) 312, a tool library 314, and an analytics database (DB) 316. The risk management system 102 may be centralized or distributed.

The risk management system 102 is briefly described as follows. The signup module 318 may be configured to allow a user (e.g., evaluee, evaluator, institution user, etc.) of the risk management system 102 to set up an account within the system 102. The signup module 318 may assign an identification factor to the user. A profile regarding the user, including the identification factor, may be stored in a user information database (DB) 312. The authentication module 302 may be configured to authenticate the login information (e.g., the identification factor) provided by or related to a user 108. The tool selection module 304 may be configured to select a risk assessment tool from, e.g., a tool library 314. The tool library maintenance module 320 may be configured to maintain the tool library 314. The maintenance may be achieved by allowing a tool already in the tool library 314 to be updated, or by allowing a new risk assessment tool to be added to the tool library 314, or the like. The maintenance may be performed by, e.g., a tool developer. The tool development module 324 may be configured to facilitate tool development by, e.g., a tool developer. The assessment module 306 may be configured to conduct a risk assessment based on a selected risk assessment tool and information from or related to an evaluee to generate a first result with respect to the evaluee. The first result may be associated with a first behavior outcome of the evaluee. The analytics module 308 may be configured to perform analytics with respect to the evaluee based on various input related to the evaluee and/or a set of one or more people discussed further elsewhere in the present disclosure. The analytics performed by the analytics module 308 may generate a second result associated with a second behavior outcome of the evaluee. The second behavior outcome may be the same as or different from the first behavior outcome. The input related to the set of one or more people may be retrieved from an analytics database (DB) 316. The analytics database maintenance module 322 may be configured to maintain the analytics database 316 based on, e.g., an analytics result with respect to the evaluee, information and/or analytics results with respect to a set of one or more people. The set may include one or more people in the same or similar communities, one or more people from the same or similar institutions (e.g., prisons or jails, mental institutions, outpatient clinics, drug treatment centers, half-way houses, hospitals, schools or universities, etc.), workplaces, one or more people with the same or similar family background, diagnostic background, education background, and/or employment background, etc. The reporting module 310 may be configured to provide a report based on the first result or a change thereof, or the second result or a change thereof, or an intervention recommendation, or the like, or a combination thereof.

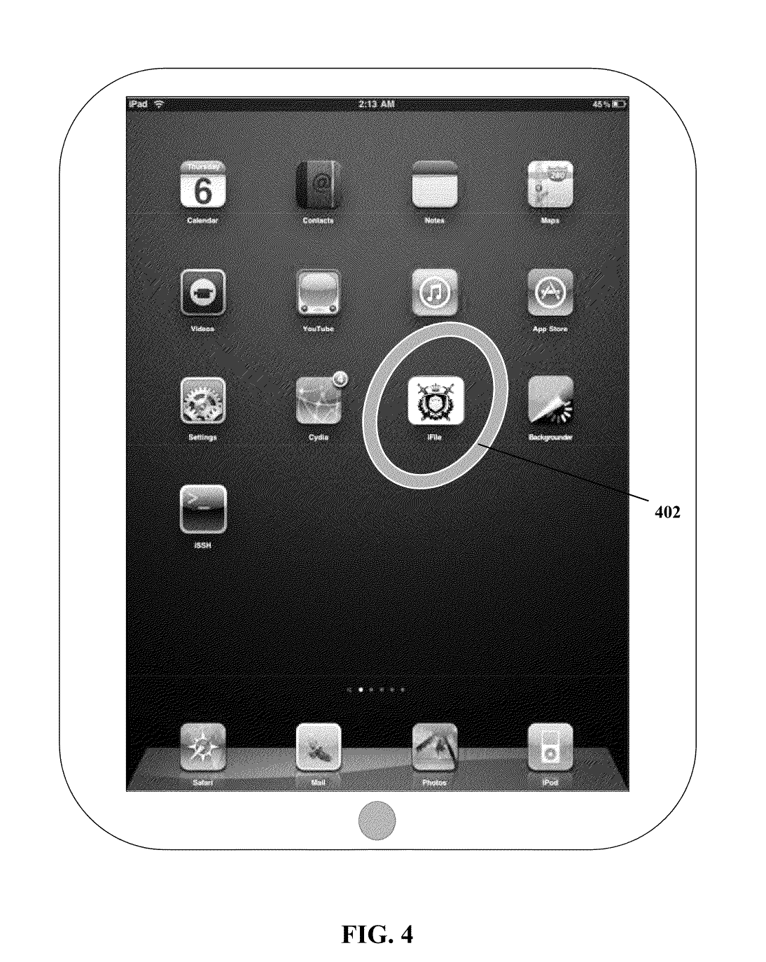

FIG. 4 illustrates an exemplary screenshot including a risk management application that constitutes a user interface of the risk management system 102 according to an embodiment of the present teaching. The icon 402 may be clicked to activate the application. The icon 402, and other icons, as well as the arrangement of the page shown in FIG. 4, are for illustration purposes, and not limiting. The page may include additional information including, e.g., time, battery life of the device on which the application is being used, the carrier of the device on which the application is being used, or the like, or a combination thereof.

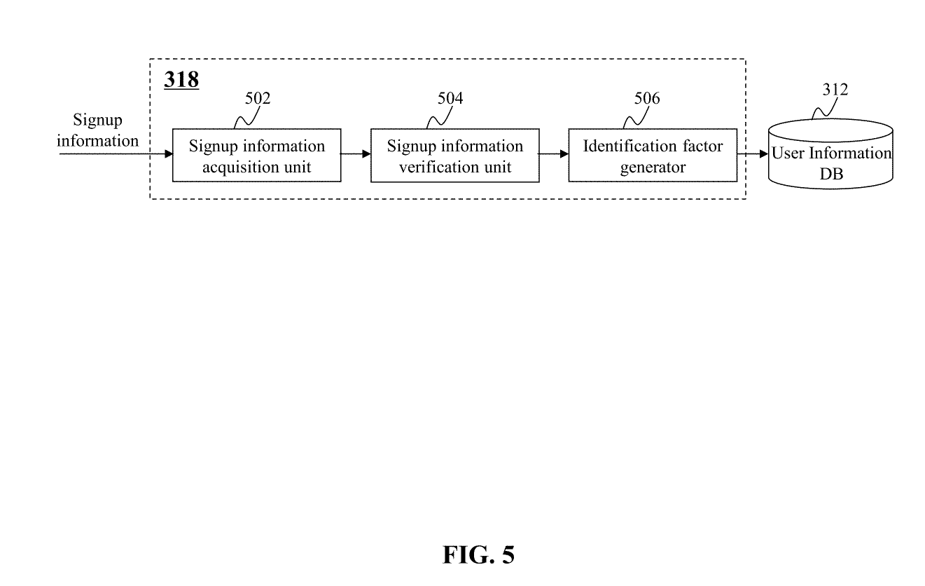

FIG. 5 illustrates an exemplary diagram of the signup module 318 according to an embodiment of the present teaching. The signup module 318 may be configured to allow a user (e.g., evaluee, evaluator, institution user, etc.) of the risk management system 102 to set up an account within the system 102. The signup module 318 may assign an identification factor to the user. The signup module 318 may include a signup information acquisition unit 502, a signup information verification unit 504, and an identification factor generator 506.

A user may sign up for an account for himself. For instance, an evaluee or an evaluator may sign up for an account for himself. A user may sign up for an account for another user. For instance, an evaluator may sign up for an account for an evaluee. As another example, an agent of an institution may sign up for an account for the institution. The user may acquire permission by the other user before the signup. The permission may be indicated by, e.g., an authorization code related to the other user or the institution, information regarding the other user or the institution, information regarding the user or the agent who is to perform the signup, or the like, or a combination thereof. The user may need to provide or prove the permission by the other user to the risk management system 102 before the signup. The risk management system 102 may keep a record of the permission for, e.g., further reference. To sign up, the user may need to provide various signup information. The signup information acquisition unit 502 may be configured to provide one or more inquiries regarding the signup to the user, and receive the signup information in response.

The signup information verification unit 504 may be configured to verify at least some of the received signup information. Although not illustrated in FIG. 5, the signup information verification unit 504 may be configured such that it may contact a person (e.g., a user) or an entity (e.g., a prison, a hospital) to verify relevant signup information. The contact may be via, e.g., the reporting module 310, or another route or mechanism. The contact may be in the form of, e.g., mail, email, phone, facsimile, text messaging, or the like, or a combination thereof. Different portions of the signup information may be verified via the same or different contact routes or mechanisms, in the same or different contact form. Merely by way of example, the signup information verification unit 504 may contact the user by email to verify his email address provided as part of the signup information. As another example, the signup information verification unit 504 may contact a hospital where the user goes (e.g., the user being an evaluee) to verify the record with respect to the user in connection with the hospital provided as part of the signup information.

The identification factor generator 506 may be configured to generate or assign an identification factor for a user. The identification factor generator 506 may be configured to allow the user himself to choose or set an identification factor. The risk management system 102 may specify some criteria for the user-chosen identification factor for security considerations. For example, the criteria include the length of the user-chosen identification factor, a combination of various types of characters to be included in the user-chosen identification factor selected from, e.g., numbers, upper case letters, lower case letters, symbols, etc., or the like, or a combination thereof. The identification factor may be used by the user for login purposes. The identification factor may be used by the risk management system 102 for reference or indexing purposes. For instance, the profile regarding the user stored in the risk management system 102 (or part of the risk management system 102) may be associated with and located using the identification factor. Alternative or in addition to the identification factor, the signup module 318 may allow the user to set other login information including, e.g., user name, user icon, password, or the like, or a combination thereof. The user may log into the risk management system 102 using at least one piece or a combination of several pieces of the login information including e.g., the identification factor, the user name, the user icon, the password, if applicable, or the like, or a combination thereof.

A profile regarding a user may be saved or stored in the user information database (DB) 312 of the risk management system 102. The profile may include, e.g., personal information (e.g., name, date of birth, date of birth, height, weight, marital status, number of children, social security number, gender, contact information (e.g., phone number, address, email, preferred way of communication, etc.)), education history, medical history (physical and/or mental health related), criminal history, employment history, accounts on social networking websites, the login information (e.g., identification factor, user name, password, user icon, etc.), at least part of the signup information, the access rights or privileges of the user with respect to the risk management system 102 (e.g., rights or privileges to access data or functions available in the risk management system 102), permission for another user (e.g., evaluator(s), a social worker, a parole officer, an institution user, a continuing professional training or education institution) to access at least part of the profile of the user, compliance information (e.g., a prescription; a refill schedule; a schedule for visiting a healthcare provider, a parole officer, or a social worker; a schedule for participating in a rehabilitation program, training program, or community service; a schedule for participating in a continuing professional training or education program or a recertification program, etc.), or the like, or a combination thereof. The profile may be updated. Update may be based on information including, e.g., a result from a risk assessment and/or analytics, or a change of any pre-existing information in the profile. The information may be provided by the user himself or by others (e.g., evaluator(s), a social worker, a parole officer, an institution user). Profiles for different types of users may include different types of information. For example, if the user is an evaluee, the profile may include one or more complete or incomplete reports from prior risk assessment or analytics, information related to prior risk assessment or analytics, or the like, or a combination thereof. If the user is a healthcare provider (e.g., an evaluator), the profile may include the credentials of the user, e.g., his training, certification, specialty, compliance information (e.g., a schedule for participating in a continuing professional training or education program, or a recertification program), or the like, or a combination thereof. If the user is an institution, the profile may include information regarding the institution. For instance, if the user is a hospital, the profile may include information regarding, e.g., its geographical location, the number of total beds, the number of occupied beds, available treatment resources, staff information, compliance information (e.g., a schedule for inspection or recertification, etc.), or the like, or a combination thereof.

Merely by way of example, a user is an evaluator. In some embodiments, the evaluator may be independent of any institution user of the risk management system 102. The evaluator may log into the risk management system 102 by providing his identification factor or other login information. In some embodiments, the evaluator may be affiliated or associated with an institution user (e.g., a hospital, a prison, a jail, an outpatient clinic, a drug treatment center, a half-way house, a mental institution, a school or university, a workplace, etc.) of the risk management system 102. The access rights or privileges of the evaluator may at least partially depend on or relate to the institution user the evaluator is associated with. In some embodiments, the evaluator may need to provide both the correct identification factor or other login information associated with himself, and the correct identification factor or other login information associated with the affiliated institution user to log into the risk management system 102. In some embodiments, if the evaluator provides the correct identification factor or other login in information associated with himself, but not the correct identification factor or other login information associated with the affiliated institution user, the evaluator may have access rights or privileges assigned to himself, but not access rights or privileges related to the institution user. To access an evaluee's profile, the evaluator may need to provide the identification factor of the evaluee, the name of the evaluee, or the like, or a combination thereof. One or more of the identification factors or other login information of the evaluee, the evaluator, and the associated institution user may be used to log into the risk management system 102 via the authentication module 302 discussed elsewhere in the present disclosure. At least part of the data available in or accessible from the risk management system 102, e.g., a completed or partial report with respect to the evaluee, may be accessed by a third party, e.g., depending on the access rights or privileges of the third party and/or the permission by the user, for review and may assist in a decision the third party makes in terms of, e.g., a treatment plan for the evaluee, resource allocation, etc.

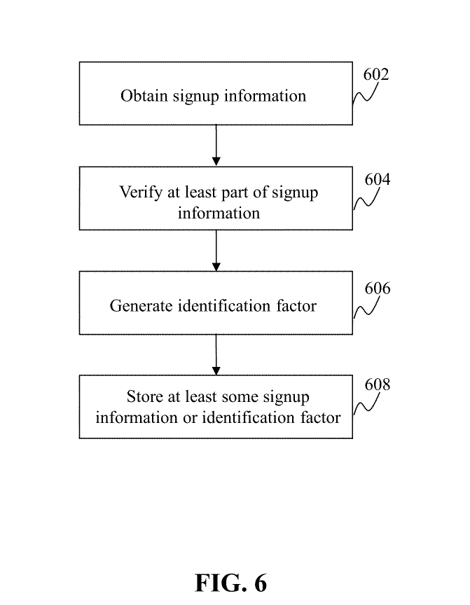

FIG. 6 illustrates a flowchart of an exemplary signup process according to an embodiment of the present teaching. A user who signs up for an account may need to provide various signup information as discussed. At 602, signup information is obtained. At 604, at least some of the signup information is verified. Merely by way of example, address, email address, phone number, or other personal information may be verified. At 606, an identification factor may be generated by, e.g., the identification factor generator 506, or chosen by the user. A profile related to the user may be compiled based on at least part of the signup information, login information including e.g., the identification factor, or the like, or a combination thereof. In some embodiments, at least some of the actions described in connection with FIG. 6 may be skipped.

At 608, at least part of the profile, including at least some of the signup information or identification factor, is stored in the risk management system 102, e.g., in the user information database 312. At least some of the signup information may be processed before it is saved in, e.g., the user information database 312. Exemplary ways of processing include encryption, compressing, or the like, or a combination thereof. In some embodiments, at least part of the profile may be transmitted to a secure database server (including relevant known hardware and software) operatively in communication with the risk management system 102 for storage and future access.

In some embodiments, the profile related to the user, including the signup information, may be revised, and relevant database(s) be updated accordingly, after the account has been created. Merely by way of example, the profile may be revised to reflect a change in, e.g., address, phone number, email, medical history, employment history, criminal history, education history, etc., of the user.

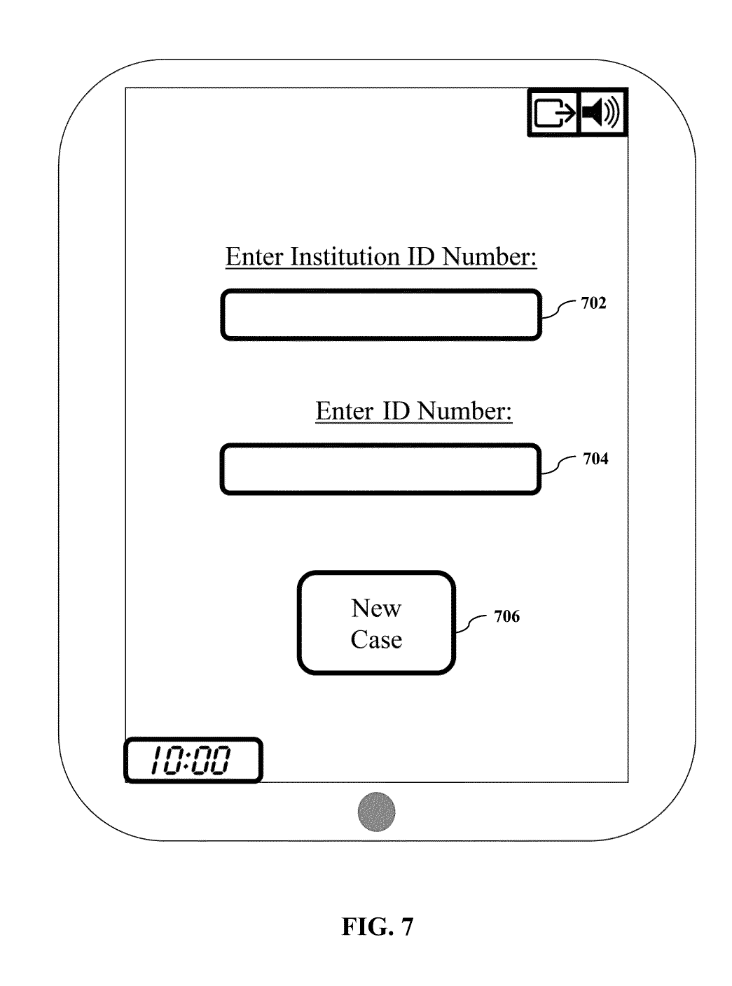

FIG. 7 illustrates an exemplary page where a signup process may be initiated in a risk management application that constitutes a user interface of a risk management system according to an embodiment of the present teaching. As illustrated, a process to sign up for an account for a new user, e.g., an evaluee, may be initiated by clicking on the “New Case” icon 706 on the exemplar page. If an evaluee is an existing user, his login information may be provided at 704. The user who performs the signup process may need to provide the login information (e.g., identification factor) of the institution (e.g., a hospital, a prison, a jail, an outpatient clinic, a drug treatment center, a half-way house, a mental institution, a school or university, a workplace) with which he is associated (or where the new user visits or stays) at 702. In some embodiments, the user who performs the signup process may need to provide the login information of his own, in addition to the login information of the institution. The page may include other content including, e.g., time, duration of a session (in which a user is logged in the application or has been working on a case with, e.g., an evaluee), time remaining in the session, a logo of a related entity (e.g., the provider of the application or risk management system 102), identity (e.g., in the form of identification factor) of the institution and/or the user (e.g., evaluee or evaluator), an icon indicating whether the device on which the application is being administered is muted or not (the icon may be clickable to mute or un-mute the device), an icon that is clickable to allow a user to go back to a previous page, the home page, or exit the application, a link to the terms or conditions of use, or the like, or a combination thereof.

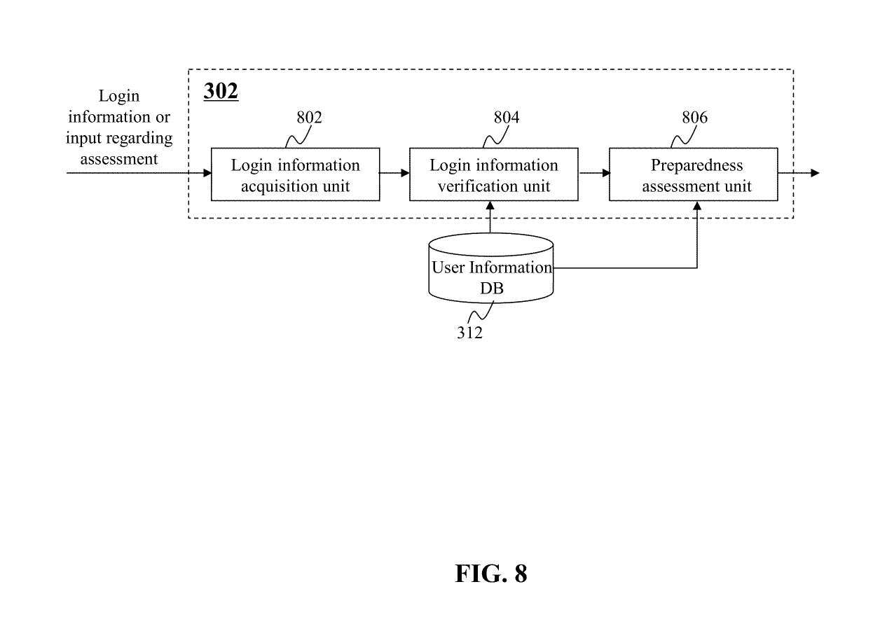

FIG. 8 illustrates an exemplary diagram of the authentication module 302 according to an embodiment of the present teaching. The authentication module 302 may be configured to authenticate the login information (e.g., the identification factor) provided by or related to the user 108. The authentication module 302 may include a login information acquisition unit 802, a login information verification unit 804, and a preparedness assessment unit 806. The login information acquisition unit 802 may be configured to receive login information provided by a user. The login information of a plurality of users may be provided. Merely by way of example, an evaluator needs to perform a risk assessment or analytics for an evaluee via the risk management system 102, the evaluator may need to provide the login information of himself (and/or of the affiliated institution) and/or the login information of the evaluee.

The received login information may be forwarded to the login information verification unit 804 to be verified based on relevant information in the risk management system 102, e.g., that saved in the user information database 312. If the login information provided by the user is inaccurate, the user may be informed accordingly and/or prompted to re-enter the login information. If the number of failed login attempts exceeds a threshold, the user may be informed accordingly, and/or the account the user attempts to access may be locked.

The preparedness unit 806 may be configured to assess the preparedness of a user, or a plurality of users. In the example described above in which the evaluator needs to perform a risk assessment or analytics for the evaluee via the risk management system 102, the preparedness of the evaluator and/or of the evaluee may be assessed using the preparedness assessment unit 806. The preparedness of the evaluator may be assessed based on, e.g., his training, prior experience, certification in administrating a risk assessment or analytics, the duration that the evaluator has been working without a break before the current session with the evaluee, existence of any condition with respect to the evaluator that may interfere with the session, etc. The preparedness assessment of the evaluator may be based on the information saved in the risk management system 102 (e.g., in the user information database 312), provided by the evaluator (e.g., as part of the authentication or login process), provided by the evaluee (e.g., the knowledge or observation by the evaluee), provided by a person related to the evaluator (e.g., a colleague, a supervisor, an assistant, etc.) or the evaluee (e.g., his guardian, a social worker, etc.), or the like, or a combination thereof. The preparedness of the evaluee may be assessed based on, e.g., the reason the evaluee has come to the session with the evaluator, the condition of the evaluee present at the session (e.g., as observed by the evaluator, a person related to the evaluator, a person related to the evaluee, or as reported by the evaluee himself), or the like, or a combination thereof. Merely by way of example, preparedness of the evaluee may be assessed when the evaluator asks the evaluee one or more preliminary questions, e.g., the evaluee's name, date of birth, etc., and compares the answers to, e.g., the information saved in the risk management system 102 (e.g., in the user information database 312). The preparedness may be assessed by having the evaluee, the evaluator, or both fill out one or more questionnaires.

The authentication module 302 may be in communication with, e.g., the tool selection module 304, the assessment module 306, the analytics module 308, and/or the reporting module 310. Merely by way of example, after the authentication or login process is successfully completed, the user (e.g., the evaluator) may proceed to tool selection via the tool selection module 304, or a risk assessment via the assessment module 306, or an analytics via the analytics module 308. As another example, if the user (e.g., the evaluator) fails the authentication or login process, the reporting module 310 may provide a notification accordingly. The notification may be sent to the user, an institution or a person related to the user. The authentication module 302 may be in direct or indirect communication with other modules, units, etc., or the risk management system 102.

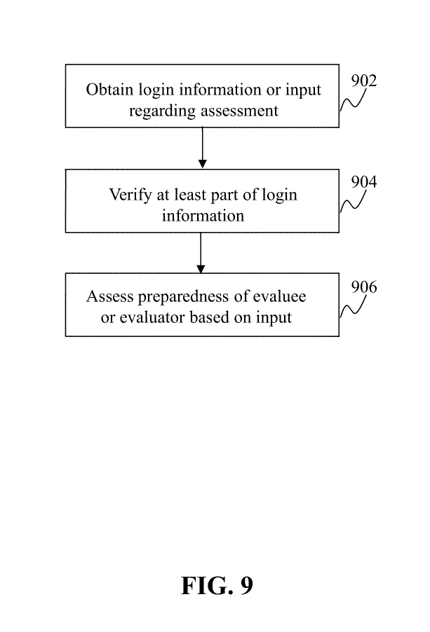

FIG. 9 illustrates a flowchart of an exemplary authentication process according to an embodiment of the present teaching. At 902, login information is obtained. At 904, at least part of the login information is verified. In some embodiments, input regarding assessment (e.g., risk assessment, preparedness assessment, etc.) is also obtained. At 906, preparedness of, e.g., an evaluee, an evaluator, or both, is assessed. In some embodiments, at least some of the actions may be skipped. For instance, preparedness assessment may be skipped.

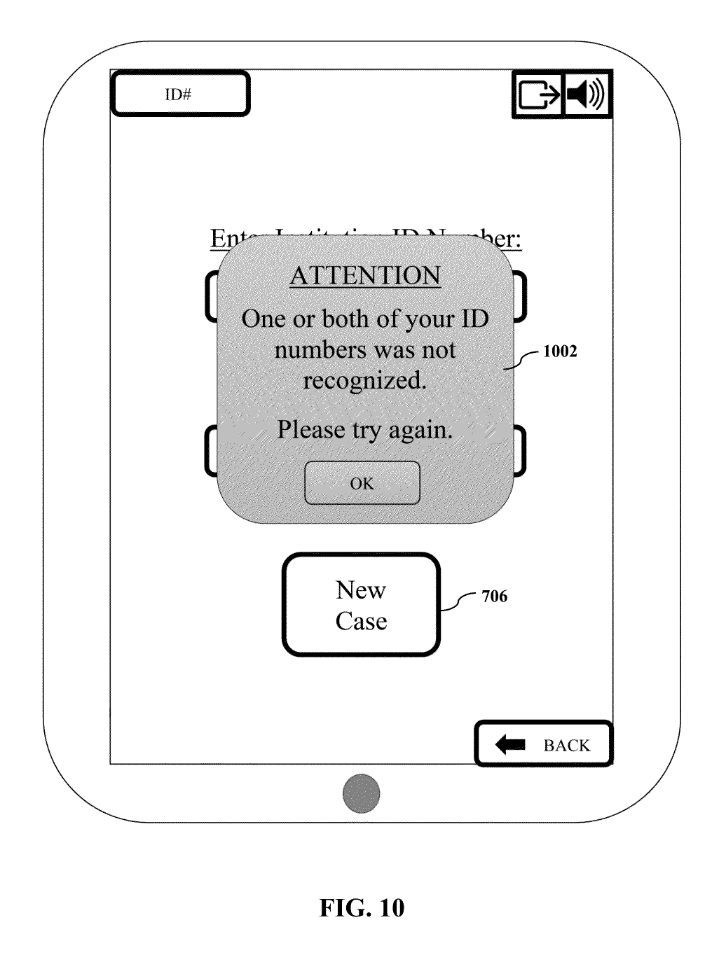

FIG. 10 illustrates an exemplary authentication page in a risk management application that constitutes a user interface of a risk management system according to an embodiment of the present teaching. If the login information provided by the user is inaccurate, the user may be informed accordingly and/or prompted to re-enter the login information as illustrated by 1002.

It is understood that any one of the authentication module 302, the signup module 318, and the user information database 312 may be part of the risk management system 102, or may operate as a stand-alone system that interfaces with other modules or part of the risk management system 102 or the risk management application, as needed.

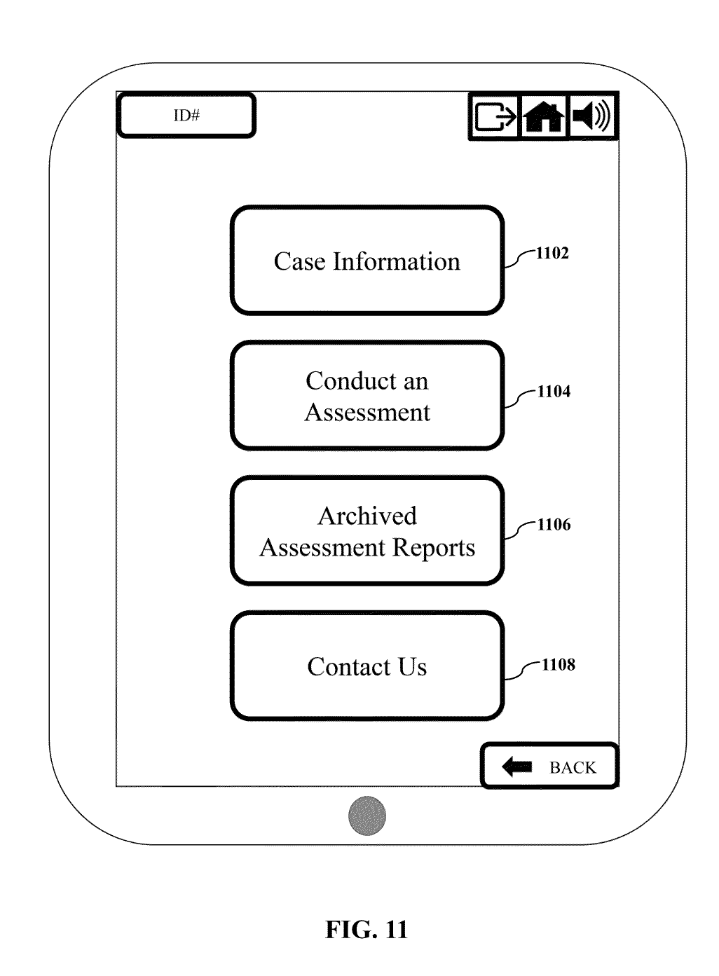

FIG. 11 illustrates a page providing exemplary options available to a user (e.g., evaluator) in a risk management application that constitutes a user interface of a risk management system according to an embodiment of the present teaching. After the authentication or login process is successfully completed, the user (e.g., the evaluator) may proceed to the tool selection via the tool selection module 304, a risk assessment via the assessment module 306, or an analytics via the analytics module 308. Merely by way of example, via the page illustrated in FIG. 11, the user may request case information by clicking the “Case Information” icon 1102, conduct an assessment by clicking the “Conduct an Assessment” icon 1104, access archived assessment reports by clicking the “Archived Assessment Reports” icon 1106, or contact a technician or administrator of the risk management application or risk management system 102 by clicking the “Contact Us” icon 1108. Contact information regarding a tool developer may also be provided.

If the user (e.g., the evaluator) selects “Case Information,” the user may be provided with logged background information (already present in the profile) regarding, e.g., an evaluee to be evaluated. The background information may be modified to update information, which may provide an opportunity for the user to check whether the information with respect to the evaluee on the record is accurate or current, and make corrections if needed. If the user (e.g., the evaluator) selects “Archived Assessment Reports,” the user may be provided with a listing of reports from risk assessment tool(s) previously administered or completed for the evaluee and the dates on which they were submitted. The user may have the option to view an archived assessment report.

It is understood that these exemplary options available to the user are provided for illustration purposes, and not limiting. Any one of the pages illustrated in FIGS. 10 and 11 may include other content including, e.g., time, duration of a session (in which a user is logged in the application or has been working on a case with, e.g., an evaluee), time remaining in the session, a logo of a related entity (e.g., the provider of the application or risk management system 102), identity (e.g., in the form of identification factor) of the institution and/or the user (e.g., evaluee or evaluator), an icon indicating whether the device on which the application is being administered is muted or not (the icon may be clickable to mute or un-mute the device), an icon that is clickable to allow a user to go back to a previous page, the home page, or exit the application, a link to the terms or conditions of use, or the like, or a combination thereof.

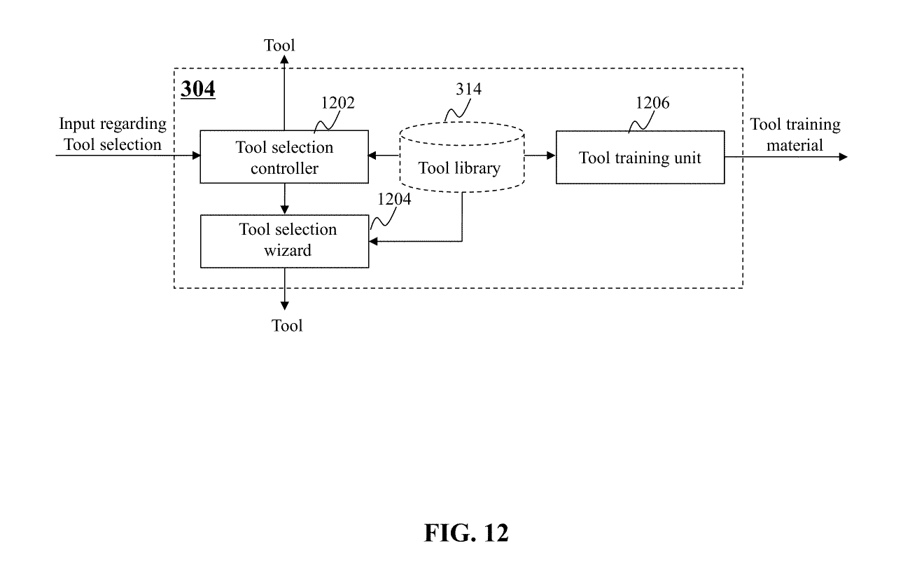

FIG. 12 illustrates an exemplary diagram of the tool selection module 304 according to an embodiment of the present teaching. The tool selection module 304 may be configured to select a risk assessment tool from, e.g., a tool library 314. The tool selection module 304 may include a tool selection controller 1202, a tool selection wizard 1204, and a tool training unit 1206. The tool selection module 304 may be in communication with a tool library 314 (shown in phantom in FIG. 12). The tool library may have one or a plurality of risk assessment tools accessible to the tool selection module 304, and to users of the risk assessment system 102 via a user interface, e.g., a risk assessment application disclosed herein. In the exemplary embodiment illustrated in FIG. 12, the tool library 314 is accessible by but not part of the tool selection module 304. The tool selection module 304 may be in direct or indirect communication with other modules, units, etc., or the risk management system 102.

The tool selection controller 1202 may be configured to receive input regarding tool selection. Tool selection may be performed manually or via the tool selection wizard 1204. If a user elects to select a risk assessment tool manually, the tool selection controller 1202 may obtain input provided by the user regarding the tool, and retrieve the tool from the tool library 314. In some embodiments, the user is provided with a listing of risk assessment tools available to be selected from, and the input may include the selection provided by the user (e.g., the user clicking on the risk assessment tool). In some embodiments, the input includes the name of the risk assessment tool provided by the user. The tool selection controller 1202 may search and retrieve, according to the provided name, the risk assessment tool from the tool library 314. If no risk assessment tool is found in the tool library 314, the user may be notified accordingly. The user may also be provided with one or more options. For example, the user may be prompted to check the spelling of the risk assessment tool, or to select another tool. A user elects to select a risk assessment tool via the tool selection wizard 1204. The tool selection wizard 1204 may assist tool selection by asking the user a series of questions or inquiries. The questions or inquiries may concern, e.g., the evaluee, the intended population, outcome or results, and the setting of the assessment, or the like, or a combination thereof. Input from the user in response to inquiries of the tool selection wizard 1204 may be used to retrieve one or more potential risk assessment tools from the tool library 314. The user may select a risk assessment tool from the one or more potential risk assessment tools. A user may access, via the tool training unit 1206, tool training material in the form of, e.g., manual, a mock risk assessment session, audio, video, etc.

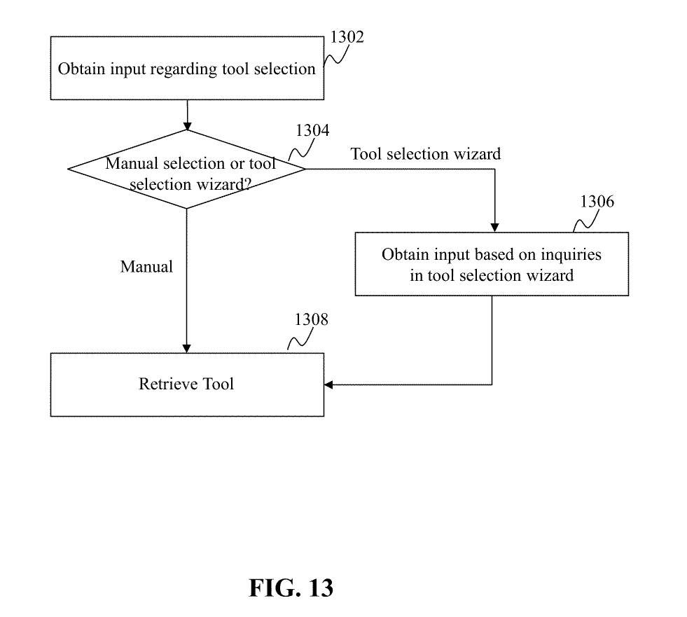

FIG. 13 illustrates a flowchart of an exemplary tool selection process according to an embodiment of the present teaching. Input regarding tool selection is obtained at 1302. At 1304, a user may elect whether to perform the tool selection manually or using the tool selection wizard 1204. A risk assessment tool may be selected manually at 1308, if the user elects to do so. A risk assessment tool may be selected using the tool selection wizard 1204. The user may be asked a series of questions including, e.g., whether the user wants to administer a risk assessment (e.g., a structured instrument for risk assessment) designed for use with adults, juveniles, or it does not matter; whether the user wants to administer a risk assessment designed for a non-forensic population, a forensic population, or it does not matter; and whether the user wants to administer a risk assessment designed for the prediction of an institutional outcome, the prediction of a community outcome, or it does not matter. Input from the user in response to inquiries in the tool selection wizard 1204 is obtained at 1306. One or more potential risk assessment tools may be retrieved, according to the input, from the tool library 314. At 1308, a risk assessment tool may be selected from the retrieved one or more potential risk assessment tools. In some embodiments, at least some of the actions described in connection with FIG. 13 may be skipped.

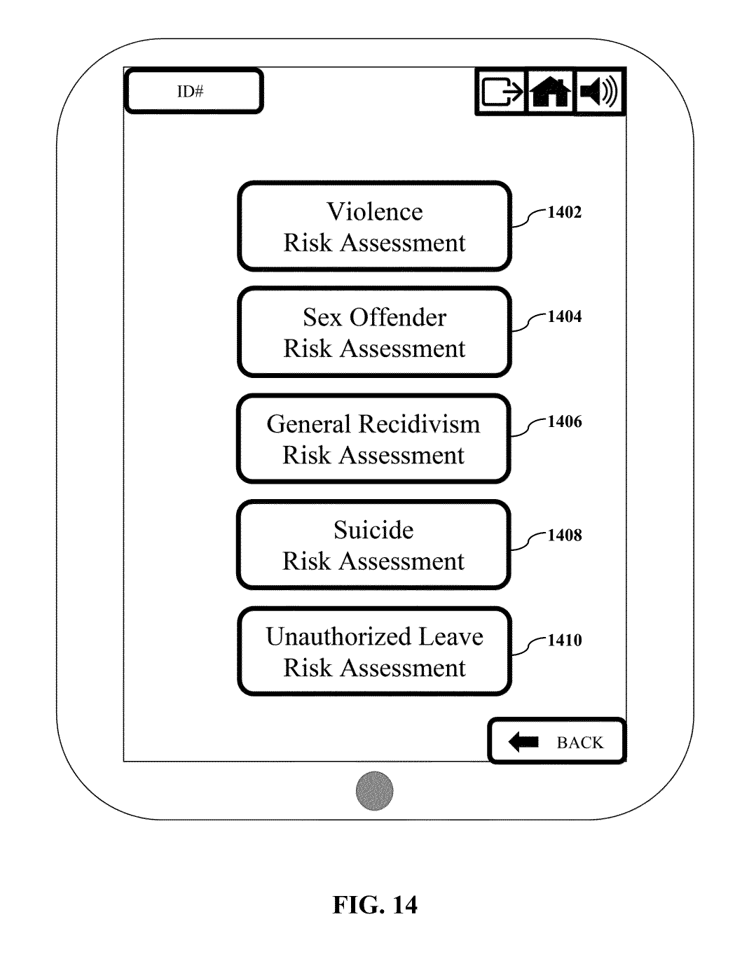

FIGS. 14-16 illustrate exemplary pages related to the tool selection in a risk management application that constitutes a user interface of a risk management system according to embodiments of the present teaching. FIG. 14 illustrates exemplary types of risk assessment in a risk management system according to an embodiment of the present teaching. The user may be brought to the page illustrated in FIG. 14 by clicking on the “Conduct an Assessment” icon 1104 shown in FIG. 11. These exemplary types of risk assessment include violence risk assessment 1402, sex offender risk assessment 1404, general recidivism risk assessment 1406, suicide risk assessment 1408, and unauthorized leave risk assessment 1410. The page illustrated in FIG. 14 may allow an evaluator to select the type of outcome or results for which the user would like to obtain by conducting a risk assessment with an evaluee. Risk assessment tools in the tool library 314 may be indexed or categorized based at least partially on the types of outcome or results provided by the risk assessment tools. There may be some overlap regarding the types of outcome or results provided by the risk assessment tools. For instance, a risk assessment tool may provide both a result related to violence risk and a result related to sex offender risk. Such a risk assessment tool may belong to both the violence risk assessment category, and the sex offender risk assessment category.

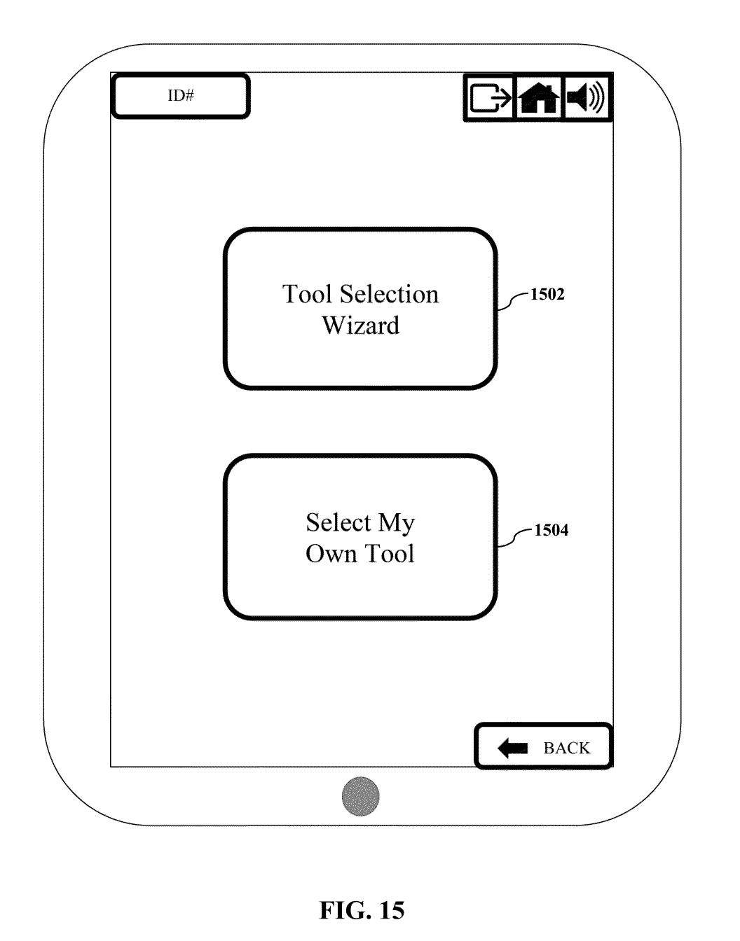

FIG. 15 illustrates an exemplary tool selection page in a risk management application that constitutes a user interface of a risk management system according to an embodiment of the present teaching. The page illustrated in FIG. 15 may allow the user to identify how the user would like to select the risk assessment tool to be administered. If the user already knows a specific risk assessment tool the user wishes to use, the user may manually select from the tool library 314 including a plurality of risk assessment tools. In this circumstance, the user may click on the “Select My Own Tool” icon 1504.

The user may use the tool selection wizard by clicking on the “Tool Selection Wizard” icon 1502. The tool selection wizard may assist the evaluator in selecting a risk assessment tool by asking the evaluator a series of questions or inquiries. The questions or inquiries may concern, e.g., the evaluee, the intended population, outcome or results, and the setting of the assessment. Based on the input of the user in response to the questions or inquiries, one or more risk assessment tools may be retrieved and provided to the user. The user may select one risk assessment tool therefrom.

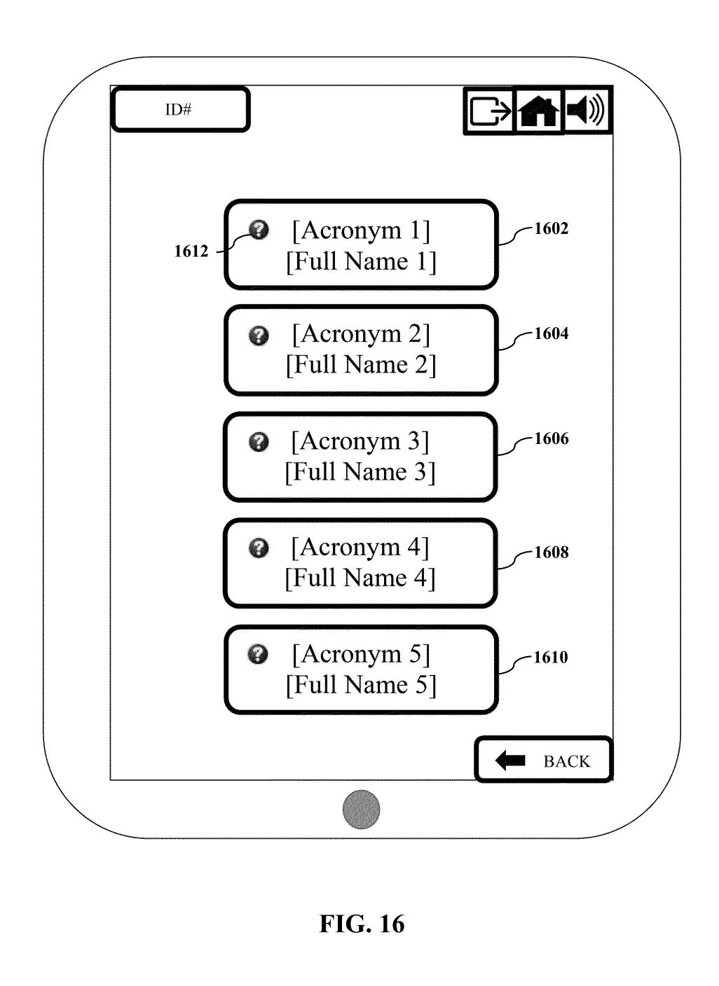

FIG. 16 illustrates a page displaying the acronyms and full names of exemplary risk assessment tools in a risk management system according to an embodiment of the present teaching. These exemplary risk assessment tools may be retrieved based on the user input in response to inquiries of the tool selection wizard 1204. These exemplary risk assessment tools may be those retrieved base on the selection the user has made on the page illustrated in FIG. 14, if the evaluator elects not to use the tool selection wizard. At least some of the icons 1602, 1604, 1606, 1608, and 1610 are interactive. For instance, if the user clicks the question mark 1612 on the icon 1602, a window may pop up in which a description of the risk assessment tool is provided. The description may include, e.g., intended population, intended outcome, the number of items in the risk assessment tool, the estimated administration time of the risk assessment tool, whether the risk assessment tool contains risk factors, protective factors, static factors, and/or dynamic factors, or the like, or a combination thereof.

Any one of the pages illustrated in FIGS. 14-16 may include other content including, e.g., time, duration of a session (in which a user is logged in the application or has been working on a case with, e.g., an evaluee), time remaining in the session, a logo of a related entity (e.g., the provider of the application or risk management system 102), identity (e.g., in the form of identification factor) of the institution and/or the user (e.g., evaluee or evaluator), an icon indicating whether the device on which the application is being administered is muted or not (the icon may be clickable to mute or un-mute the device), an icon that is clickable to allow a user to go back to a previous page, the home page, or exit the application, a link to the terms or conditions of use, or the like, or a combination thereof.

A risk assessment tool is fixed, based on fixed tool reference data, unless or until a tool developer updates the tool. As used herein, “tool provider,” “tool developer,” “tool publisher,” “publisher,” and “tool IP holder” may be used interchangeably. The risk management system 102 allows a tool developer to update a risk assessment tool saved in the risk management system 102. The risk management system 102 does not update a risk assessment tool based on, e.g., the risk assessment result of an evaluee using the risk management system 102. Exemplary methods of developing a risk assessment tool are described below. A tool may be developed using, e.g., the tool development module 324. The tool development module 324 may be configured to facilitate tool development by, e.g., a tool developer. The tool development module 324 may have a user interface through which a tool developer with appropriate access rights or privilege may access the risk management system 102 to perform the tool development task. The tool developer may access, e.g., the analytics database 316, and use information available in the analytics database 316 to develop a risk assessment tool. The risk management tool developed using the tool development module 324 may be added to the tool library 314 via, e.g., the tool library maintenance module 320 discussed elsewhere in the disclosure.

As an example, an actuarial risk assessment tool may be developed as follows. A tool developer may collect, e.g., biological, psychological, and/or sociological characteristics of a specified sample of individuals. The tool developer may follow the sample, e.g., for a specified period of time. The tool developer may identify which individuals in the sample engaged in the outcome of interest, e.g., in the specified period of time, using specified sources of outcome information including, e.g., criminal records, self-reports, and collateral reports. An outcome of interest may be, e.g., a violent act against the individual himself or herself, against a victim, a substance abuse relapse, etc. The tool developer may statistically identify the set of characteristics that accounts for the greatest amount of variance in predicting the outcome of interest in the sample. This may be done using, e.g., a non-parametric statistical methodology (e.g., logistic regression, Cox regression, chi-squared automatic interaction detection, random foresting). Exemplary characteristics may include criminal history factors, sociodemographic characteristics, clinical characteristics, physiological or biological characteristics, behavioral characteristics, psychological characteristics, sociological characteristics, or the like. Listed below are some examples of such characteristics.

Exemplary criminal history factors include previous and/or current violence, previous and/or current sexual offense, prior conditional release failure/escapes, previous nonviolent offense, inpatient aggression or self-harm, frequency and seriousness of arrests as an adult, frequency and seriousness of arrests as a juvenile, gender of victim (for index offense), parental history of arrest, previous and/or current threats (verbal or physical), previous and/or current use of weapons, previous property offense, previous sentences resulting in incarceration/hospitalization, previous sexual offense, severity of victim injury (for index offense), or the like.

Exemplary sociodemographic characteristics include employment, exposure to destabilizers, social support, economic/financial situation, intimate relationship, age at assessment, leisure/recreational activities, age at first violent conviction/incident, frequency and quality of socializing, sex, homeless, lived with both biological parents during childhood, living conditions supervised by mental health professionals, marital history, occupational skillset/training, social skills, acculturation problems, age at first hospitalization, age at index offense, contact with biological, adopted, or stepchildren, contact with family, criminal peers, ethnicity, level of education, living alone, living in private residence, security level of release setting, or the like.

Exemplary clinical characteristics include previous and/or current substance abuse, insight into illness and/or behavior, previous and/or current symptoms of psychosis, coping, impulsivity/impulse control, medication/medication compliance, previous and/or current diagnosis of a personality disorder, treatability/motivation for treatment, criminal/negative attitudes, planning/future plans, psychopathy, self-care/ability to perform daily chores, affective state (elevated or depressed mood), agreement on conditions/rules, early adjustment, empathy, previous and/or current diagnosis of major mental illness, contact with community support worker, history of inpatient psychiatric treatment, hostile reaction style, mandatory treatment or probation order, previous and/or current diagnosis of a psychotic disorder, previous and/or current diagnosis of schizophrenia, previous and/or current symptoms of anxiety, responsibility toward crime, suicidal ideation, threats, or previous suicide attempt, attachment style in childhood, contact with physical health care services, global assessment of functioning, history of treatment in correctional institution, homicidal thoughts, intelligence, number of prior hospitalizations, personal problem present at intake, previous and/or current diagnosis of a mood disorder, recent change in medication, schedule of imagined violence, self-report of future violence risk, self-report of overall physical and mental health, self-report of overall quality of life, sexual preoccupation, stress level, suspiciousness, parental alcohol abuse, parental drug abuse, parental hospitalization, parents argued, victim of child abuse, violent lifestyle, sadism, or the like.

Exemplary physiological/biological characteristics include a history of head injury (with or without loss of consciousness), corticosteroid levels, cholesterol, blood pressure, blood platelet count, heart rate, length and/or quality of sleep, genomic markers of behavioral risk, amount of exercise, or the like.

At least some of these and other characteristics may be considered in the process of developing a risk assessment tool. The tool developer may weigh the characteristics using, e.g., unit weighting (i.e., presence=1, absence=0), base rate weighting (i.e., presence/absence is associated with increase/decrease in base rate, and each percentage difference in base rate is given a weight), or effect size weighting (i.e., effect sizes from the non-parametric statistical analyses such as odds ratios are used). Using the weighting system, the tool developer may identify a total score for an individual in the sample. The tool developer may then determine the distribution of the number of individuals in the sample and their respective total scores. The tool developer may identify how many individuals in the sample went on to engage in the outcome of interest, e.g., within the specified period of time, using the specified sources of outcome information. The tool developer may then create a table or figure listing total scores (or range of scores) in relation to the percentage of the sample which engaged in the outcome of interest, e.g., within the specified period of time, using the specified source(s) of information. Alternative to total scores, it is possible to collapse total scores into different “risk bins” (e.g., “Low Risk,” “Moderate Risk,” and “High Risk”). In such a model, the percentage of the sample which are engaged in the outcome of interest, e.g., in the specified period of time, using the specified source(s) of information, are presented in relation to such risk bins rather than for each of the total scores. The tool developer may create a coding sheet accordingly in order to assist with the administration of the risk assessment tool. The coding sheet may include a manual that may provide the operational definitions of one or more items therein to assist with coding or the administration of the risk assessment tool. The manual may also include a rationale or justification for the inclusion of an item, a rule such as a prorating procedure, or the like, or a combination thereof.

As another example, a structured professional judgment risk assessment tool may be developed as follows. A tool developer may conduct a systematic search using electronic databases and either one or a combination of keywords relevant to the prediction of an outcome of interest in a population of interest. The tool developer may identify risk factors and/or protective factors most commonly associated with the outcome of interest in the population of interest using a standardized coding sheet such as that illustrated in Table 1.

TABLE 1

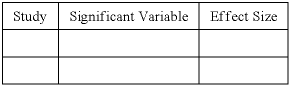

The tool developer may combine the identified static and/or dynamic risk factors and/or protective factors into subscales based on common themes (e.g., a Criminal History subscale may be made out of the following three items: Prior Conviction, Juvenile Delinquency, Index Offense with Multiple Victims). The tool developer may then develop a coding sheet to be used by the individual administering the risk assessment tool. Merely by way of example, the coding sheet may have an ordinal coding scale for each static and/or dynamic risk and/or protective factor (e.g., 0=Definitely Not Present; 1=Maybe Present; 2=Definitely Present). The coding sheet may also include an ordinal summary risk rating (e.g., Low Risk, Moderate Risk, High Risk) that may be used by an evaluator administering the risk assessment tool to make a final risk judgment (or risk assessment result) taking into consideration of the static and/or dynamic risk factors and/or protective factors from the subscales as well as case-specific information as exemplified in Table 2. The coding sheet may include a manual that may provide the operational definitions of one or more items therein to assist with coding and/or the administration of the coding sheet by an evaluator. The manual may also include a rationale or justification for the inclusion of an item, a rule such as a prorating procedure, or the like, or a combination thereof.

TABLE 2

| Risk/ | Definitely | Maybe | Definitely |
|---|---|---|---|
| Protector Factor | Not Present | Present | Present |
| Scale 1 | | | |
| Factor 1 | | | |
| Factor 2 | | | |
| Factor n | | | |
| . . . | | | |
| Scale n | | | |
| Factor 1 | | | |
| Factor 2 | | | |
| Factor n | | | |
| FINAL RISK | LOW | MODERATE | HIGH |
| JUDGMENT | | | |

The tool library 314 having one or a plurality of risk assessment tools may be organized, e.g., in alphabetical order and/or based on categories. As discussed, the categories may be based on, e.g., the type of outcome or results a risk assessment tool may provide, the applicable population, etc. For instance, a plurality of risk assessment tools in the tool library 314 may be organized based on categories, and those risk assessment tools within a category may be organized in alphabetic order. A risk assessment tool may belong to more than one category. The tool library 314 may include risk assessment tools provided by one or more third parties. A risk assessment tool already in the tool library 314 may be updated remotely by, e.g., the tool provider who has appropriate permission or access rights/privileges. A tool developer who has appropriate permission or access rights/privileges may add a new risk assessment tool to the tool library 314.

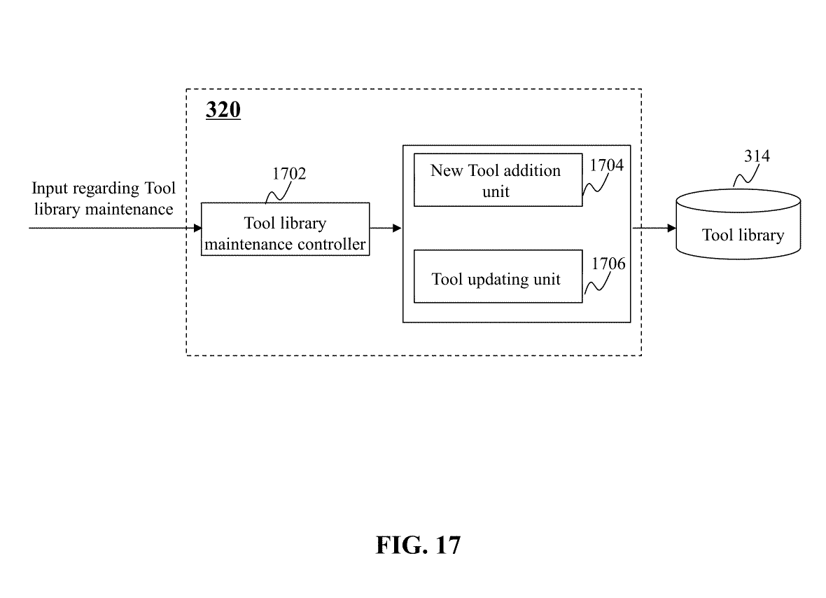

FIG. 17 illustrates an exemplary diagram of a tool library maintenance module 320 according to an embodiment of the present teaching. The tool library maintenance module 320 may be configured to maintain the tool library 314. The maintenance may be achieved by allowing a tool already in the tool library 314 to be updated, or by allowing a new risk assessment tool to be added to the tool library 314, or the like. The maintenance may be performed by, e.g., a tool developer.

An application programming interface (API) may be included. Via the API, a tool developer (e.g., a third-party tool developer) may be allowed (e.g., with proper authorization) to integrate its risk assessment tool(s) to the risk management system 102 such that the risk assessment tool becomes available (for use or purchase) to users. The risk management system 102 may be configured such that a user (e.g., an evaluator, an evaluee, an institution) may purchase a risk assessment tool from within the risk management system 102. Peer-reviewed research applicable to risk assessment tools available on the software platform may be made available via, e.g., an e-reader.

The tool library maintenance module 320 may include a tool library maintenance controller 1702, a new tool addition unit 1704, and a tool updating unit 1706. The tool library maintenance controller 1702 may be configured to determine one or more actions to be performed based on input regarding tool library maintenance provided by a user, e.g., a tool developer. For instance, if the user wishes to add a new risk assessment tool into the tool library 314, the tool maintenance controller 1702 may determine one or more actions to be performed by the new tool addition unit 1704. The one or more actions may include, e.g., saving the new risk assessment tool in the tool library 314, indexing the new risk assessment tool (e.g., in alphabetical order and/or based on category), etc. As another example, if the user wishes to update a risk assessment tool already in the tool library 314, the tool maintenance controller 1702 may determine one or more actions to be performed by the tool updating unit 1706. The one or more actions may include, e.g., replacing the old version of the risk assessment tool with the new version, updating the version of the risk assessment tool already in the tool library 314 by adding or replacing a patch, etc.

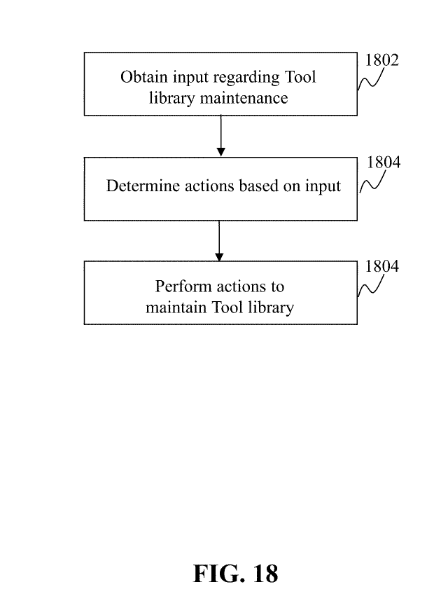

FIG. 18 illustrates a flowchart of an exemplary process of maintaining the tool library 314 according to an embodiment of the present teaching. At 1802, input regarding tool library maintenance is obtained. Based on at least part of the input, a determination is made at 1804 regarding one or more actions to be performed. At 1806, the one or more actions are performed to maintain the tool library 314. In some embodiments, at least some of the actions described in connection with FIG. 18 may be skipped.

This is understood that any one of the tool selection module 304, the tool library maintenance module 320, and the tool library 314 may be part of the risk management system 102, or may operate as a stand-alone system that interfaces with other modules or part of the risk management system 102 or the risk management application, as needed.

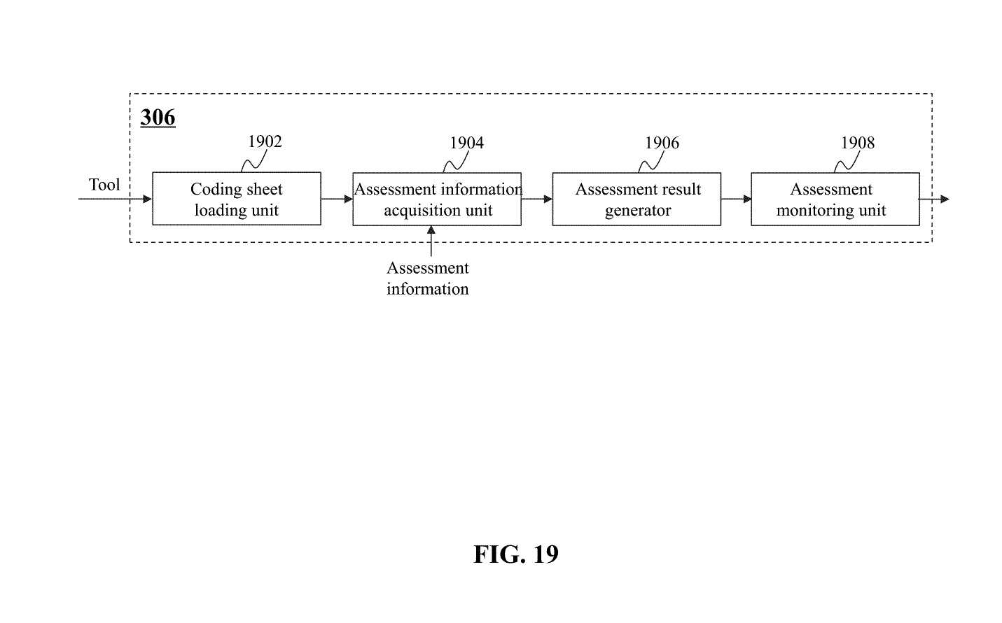

FIG. 19 illustrates an exemplary diagram of the assessment module 306 according to an embodiment of the present teaching. The assessment module 306 may be configured to conduct a risk assessment based on the selected risk assessment tool and assessment information related to an evaluee to generate a result (also referred to as an assessment result). The assessment result may be associated with a behavior outcome of the evaluee. The assessment result may include at least one result selected from the group including, e.g., likelihood, frequency, severity, imminence, and a likely victim of the behavior outcome, or a change thereof. Merely by way of example, the behavior outcome may be a violent action against the evaluee himself or someone else.

The assessment module 306 may include a coding sheeting loading unit 1902, an assessment information acquisition unit 1904, an assessment result generator 1906, and an assessment monitoring unit 1908. The coding sheet loading unit 1902 may load a coding sheet based on the selected risk assessment tool. The coding sheeting may be a new one, or an existing one (e.g., from a previous risk assessment session with the same evaluee). The assessment information acquisition unit 1904 may be configured to receive assessment information, e.g., via the risk assessment tool according to the coding sheet. The assessment result generator 1906 may be configured to generate an assessment result based on at least part of the assessment information and the risk assessment tool. As discussed, the risk assessment tool may be developed based on fixed tool reference data. The risk assessment tool may be developed following e.g., a structured professional judgment approach, or an actuarial approach.

The coding sheet of the selected risk assessment tool may include one or more items. An item may be an inquiry regarding the evaluee's information, e.g., medical history, etc. An item may need the evaluator to provide a score according to a scale. For example, an item may be regarding how stable the mental state of the evaluee is based on the judgment of the evaluator, how well the evaluee adheres to a rehabilitation program, etc. For at least some of the items in the coding sheet, there may be tutorial information regarding, e.g., coding criteria (why a specific item is included in the coding sheet, how to grade the item, etc.). The tutorial information may be included in a manual for the risk assessment tool, or in a popup window that may be activated by, e.g., clicking on a portion of the coding sheet (e.g., a question mark next to the item). The assessment information related to, e.g., a criminal history, a sociodemographic characteristic, a clinical characteristic, a physiological or biological characteristic, a sociological characteristic, a behavioral characteristic, or a psychological characteristic, or a change thereof, of the evaluee. The assessment information may be provided by the evaluee or by the evaluator according to the coding sheet of the selected risk management tool. In some embodiments, the user (e.g., the evaluator) may elect to see how some items, e.g., items related to static risk factors or protective factors, were coded or graded in previous administration(s) of risk assessment of the same evaluee.

The assessment information may be provided to the assessment information acquisition unit 1904. The evaluator may specify the timeframe of the risk assessment being conducted. Merely by way of example, the evaluator may specify that the risk assessment concerns a risk with respect to a behavior outcome in the next number of hours, days, weeks, months, etc. The assessment result generator 1906 may generate an assessment result based on, e.g., at least part of the assessment information for the specified timeframe. The assessment result generator 1906 may culminate in a categorical risk judgment (e.g., Low Risk, Moderate Risk, or High Risk), or a score. In some embodiments, the evaluator may be allowed to clinically override the assessment result generated by the assessment result generator 1906. The evaluator may also add notes to at least some of the items in the coding sheet. The assessment monitoring unit 1908 may be configured to monitor the assessment information, the assessment result, or the like, or a combination thereof. For example, the assessment monitoring unit 1908 may compare the assessment information or the assessment result with a threshold, or with previous assessment information or assessment result(s) of, e.g., the same evaluee; based on the comparison, the assessment monitoring unit 1908 may make a determination regarding whether to take actions, e.g., providing a report or an alert related to the assessment information, the assessment result, or a change thereof. The report or alert, if needed, may be provided by the reporting module 310. One or more items among the assessment information may be identified to be more influential than other items with respect to the assessment result associated with the evaluee. The identified items may be protective factors and/or risk factors. The identification may be made by the evaluator, or by the assessment module 306, e.g., the assessment monitoring unit 1908.

The assessment module 306 may be in communication with at least one of the analytics module 308, the tool selection module 304, the reporting module 310, and the user information database 312. For instance, the assessment result alone or in combination with the assessment information may be forwarded to the analytics module 308 for further processing. As another example, the assessment result alone or in combination with the assessment information may be forwarded to the reporting module 310 such that a report may be generated and provided to, e.g., an institution (e.g., a hospital, a prison, a mental institution, a school or university, a workplace, etc.), a professional or employee associated with the institution, a caseworker (or social worker) associated with the evaluee, police or a police officer, a community liaison, a tool developer who develops or is interested in developing a risk assessment tool, a family member, a friend, a likely victim, an employer, a colleague, or other people or parties that are associated with or related to the evaluee or interested in risk management with respect to the evaluee, or the like. The reports sent to different people or entities may be the same or different, depending on the access rights or privileges and/or other configurations with respect to the recipients within the risk assessment system 102. At least some of the assessment information, the assessment result, or information related to the risk assessment session, may be saved in the user information database 312. For instance, the evaluator may set a re-visit time (or re-assessment time) for the evaluee to come back for a next session; the time and/or a reminder regarding the same may be saved in the user information database 312. A risk assessment session may be performed offline. The assessment information or assessment result, as well as other information related to the session (e.g., a re-visit or re-assessment schedule) may be saved on a local device (e.g., computer, tablet, laptop, etc.) and may be uploaded to the risk management system 102 (e.g., the user information database 312, etc.) or a cloud storage when the local device is connected to, e.g., the Internet. The assessment module 306 may be in direct or indirect communication with other modules, units, etc., or the risk management system 102.

This is understood that the assessment module 306 may be part of the risk management system 102, or may operate as a stand-alone system that interfaces with other modules or part of the risk management system 102 or the risk management application, as needed.

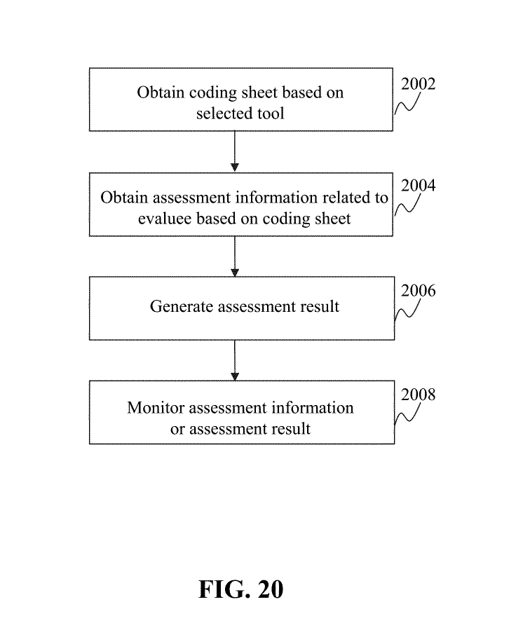

FIG. 20 illustrates a flowchart of an exemplary process of risk assessment according to an embodiment of the present teaching. At 2002, a coding sheet related to the selected risk assessment tool is obtained. The coding sheeting may be a new one, or an existing one (e.g., from a previous risk assessment session with the same evaluee). Based on the coding sheet of the selected risk assessment tool, assessment information related to the evaluee is obtained at 2004. The assessment information may be provided by the evaluee or by the evaluator according to the coding sheet of the selected risk management tool. At 2006, an assessment result is generated based on, e.g., at least part of the assessment information. The assessment result may be associated with a behavior outcome of the evaluee, and may be relevant for a specified timeframe if applicable. In some embodiments, the user (e.g., the evaluator) has the option to clinically override the assessment result. The evaluator may also add notes to at least some of the items in the coding sheet, and/or identify one or more items that are more influential than other items with respect to the assessment result associated with the evaluee. The identification may alternatively or additionally made by the assessment module 306, e.g., by the assessment monitoring unit 1908. The identified items may be protective factors and/or risk factors. The assessment information or the assessment result may be monitored at 2008. In some embodiments, at least some of the actions described in connection with FIG. 20 may be skipped. Merely by way of example, the monitoring at 2008 may be skipped.

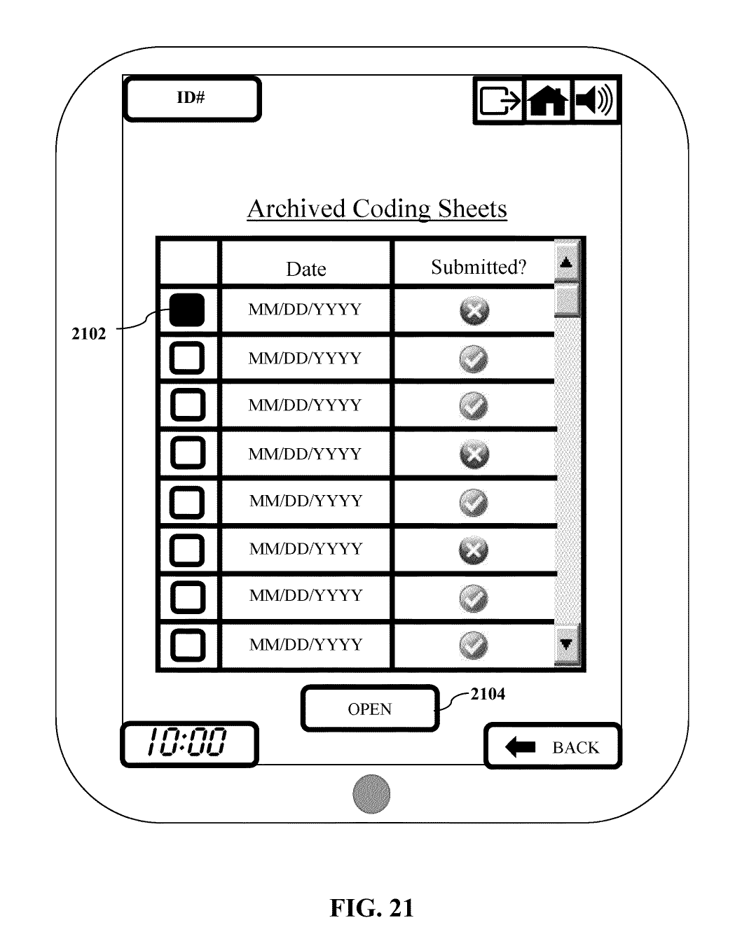

FIGS. 21-26 illustrate exemplary pages related to risk assessment according to some embodiments of the present teaching. FIG. 21 illustrates an exemplary page showing coding sheets related to a user (e.g., evaluee) archived in a risk management system according to an embodiment of the present teaching. The page shows information regarding the archived coding sheets including, e.g., the time a coding sheet was generated (or submitted, last accessed, or last revised), whether a coding sheet was submitted (e.g., whether it was finalized), etc. An archived coding sheet may be opened for use or for review. For instance, an archived coding sheet may be selected by clicking on a corresponding box 2102, and then clicking on the “Open” icon 2104. One or more archived coding sheets may be selected and opened at the same time.

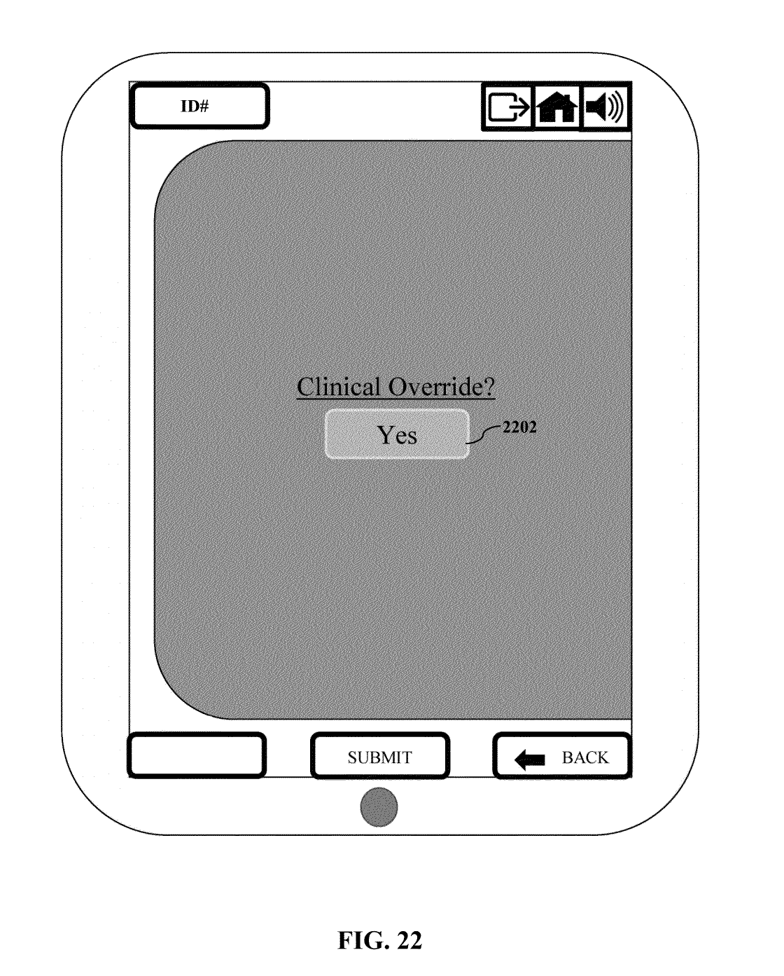

FIG. 22 illustrates an exemplary page showing the option of clinically overriding an assessment result in a risk management application that constitutes a user interface of a risk management system according to an embodiment of the present teaching. The option allows an user (e.g., an evaluator) to clinically override an assessment result generated by, e.g., the assessment result generator 1906. If the user wants to provide a clinic override (and has the proper access rights or privileges to do so), the user may click the “Yes” icon 2202 to proceed.

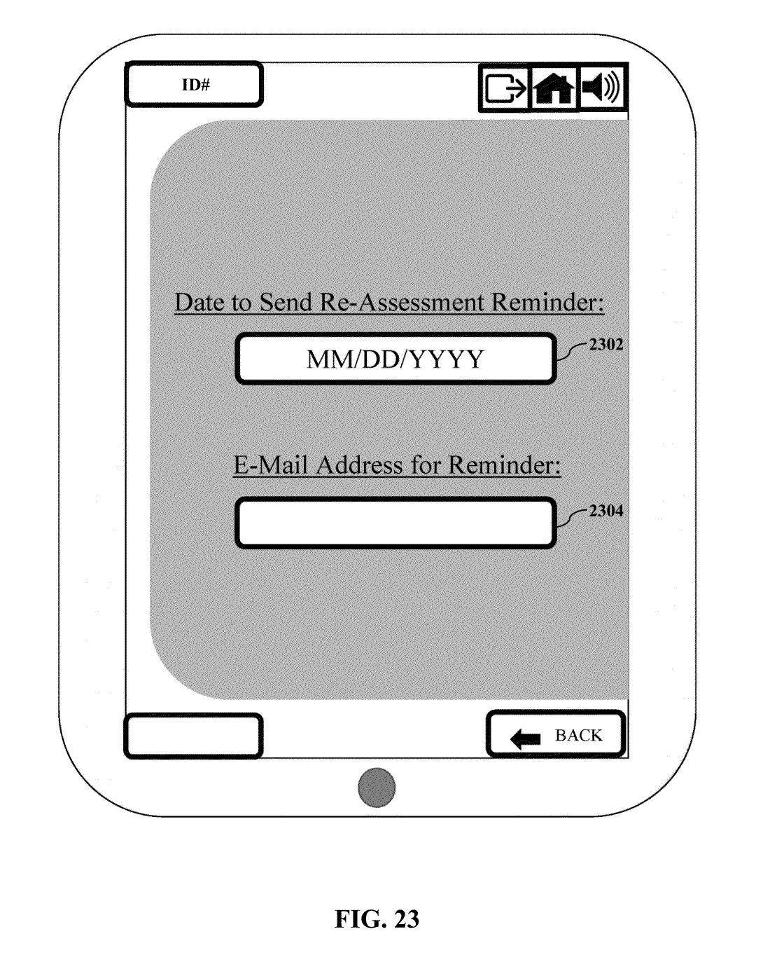

FIG. 23 illustrates an exemplary page related to setting up a reminder for a re-assessment or re-visiting of a user (e.g., evaluee) in a risk management application that constitutes a user interface of a risk management system according to an embodiment of the present teaching. The page illustrated in FIG. 23 allows the setting of a reminder for the re-assessment at 2302, and the email address where the reminder is to be sent at 2304. A reminder may be sent by one or more other ways, e.g., phone call, text message, calendar invite, or the like, or a combination thereof.

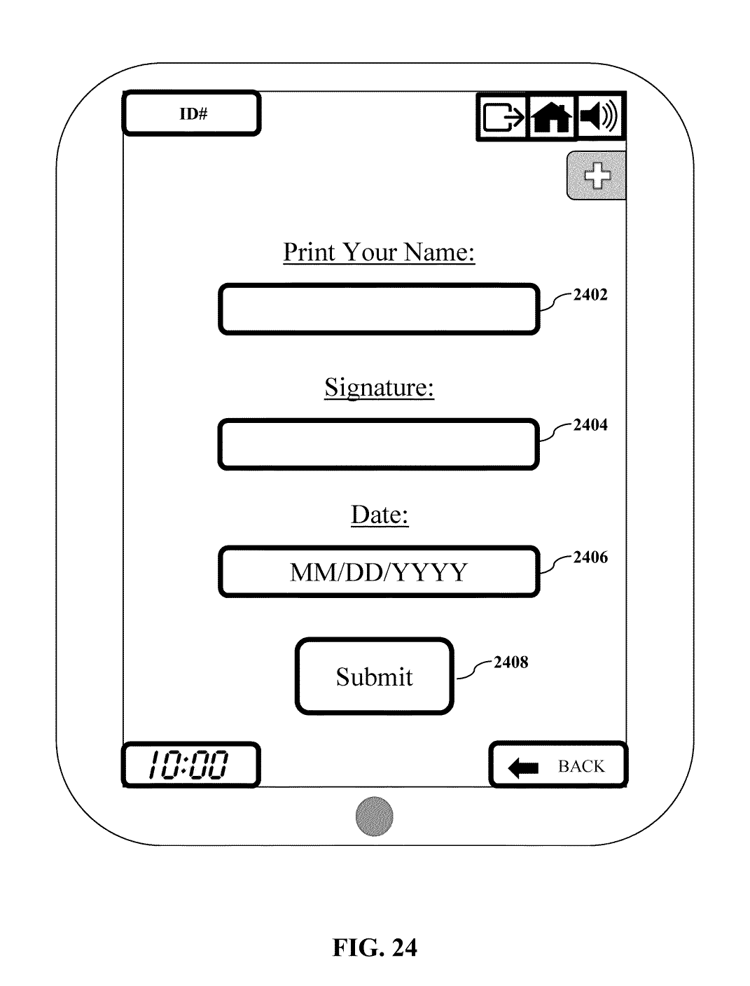

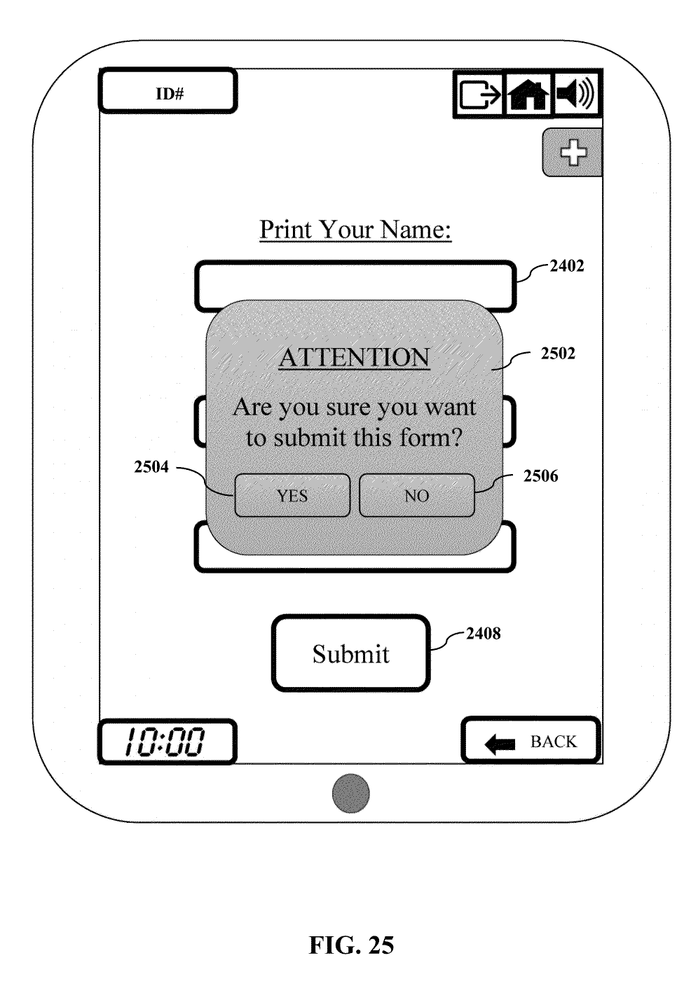

FIG. 24 illustrates an exemplary page requesting information regarding a report and a user (e.g., evaluator) according to an embodiment of the present teaching. Before an assessment result may be finalized, the user (e.g., the evaluator) may be asked to provide his name at 2402, his signature (e.g., electronic signature) at 2404, and date on which the risk assessment is administered at 2406. When the user clicks the “Submit” icon 2408, the user may be asked to confirm his intention to submit the form including at least part of the assessment result as illustrated in FIG. 25.

FIG. 25 illustrates an exemplary page requesting user confirmation for submitting a form related to an assessment in a risk management application that constitutes a user interface of a risk management system according to an embodiment of the present teaching. The user (e.g., the evaluator) may be asked to confirm his intention to submit the form including at least part of the assessment result. The user may confirm his intention to finalize the form for submission by, e.g., clicking the “YES” icon 2504. The user may indicate his intention not to finalize the form yet by, e.g., clicking the “No” icon 2506. The user may be allowed to revise the form including at least part of the assessment result, at least part of the coding sheet, provide a clinic override of the assessment result, or the like, or a combination thereof.

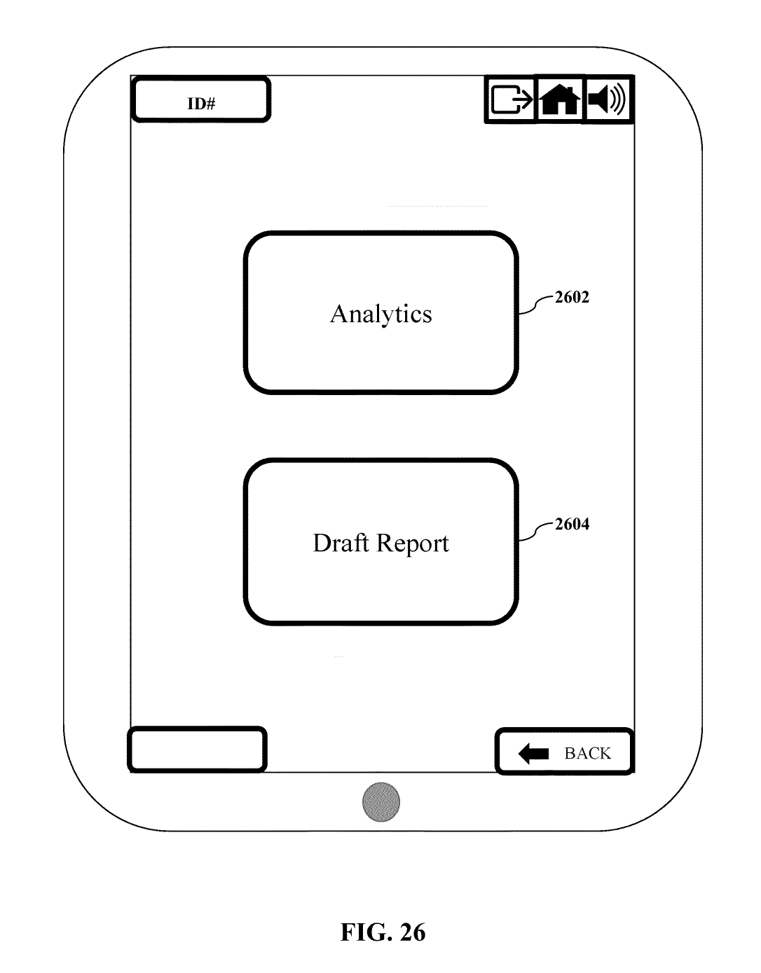

FIG. 26 illustrates a page providing exemplary options available to a user (e.g., evaluator) in a risk management application that constitutes a user interface of a risk management system according to an embodiment of the present teaching. The user may choose to proceed to the analytics by, e.g., clicking on the “Analytics” icon 2602, or to have a report drafted by, e.g., clicking on the “Draft Report” icon 2604.

Any one of the pages illustrated in FIGS. 21-26 may include other content including, e.g., time, duration of a session (in which a user is logged in the application or has been working on a case with, e.g., an evaluee), time remaining in the session, a logo of a related entity (e.g., the provider of the application or risk management system 102), identity (e.g., in the form of identification factor) of the institution and/or the user (e.g., evaluee or evaluator), an icon indicating whether the device on which the application is being administered is muted or not (the icon may be clickable to mute or un-mute the device), an icon that is clickable to allow a user to go back to a previous page, the home page, or exit the application, a link to the terms or conditions of use, or the like, or a combination thereof.

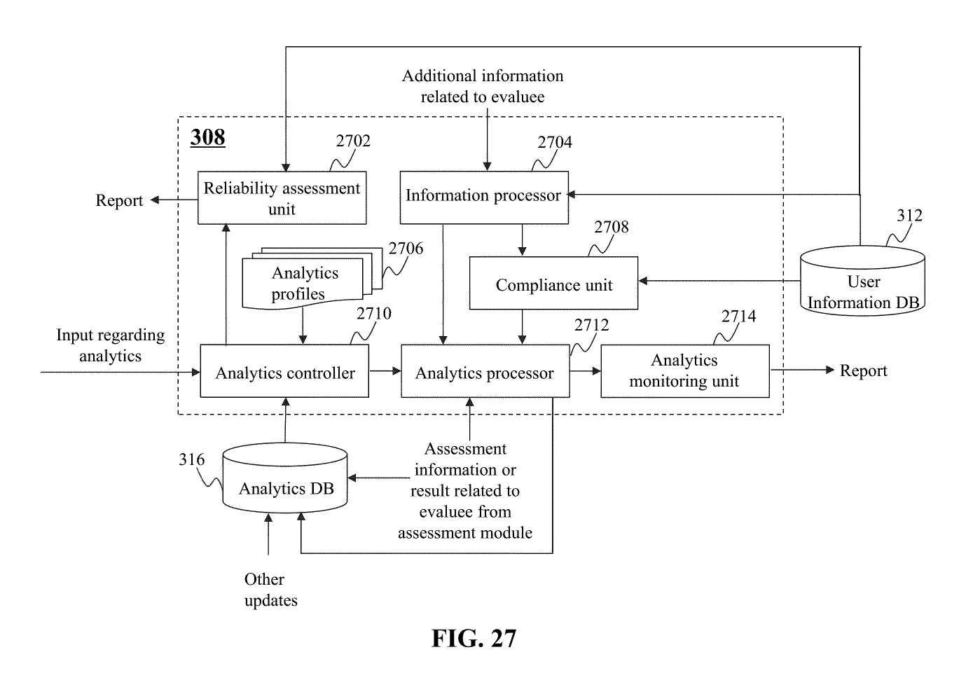

FIG. 27 illustrates an exemplary diagram of the analytics module 308 according to an embodiment of the present teaching. The analytics module 308 may be configured to perform an analytics with respect to the evaluee based on various input related to the evaluee and/or a set of one or more people. The analytics module 308 may be configured to receive, at a processor, a first result associated with a first behavior outcome based on first information related to an evaluee, second information related to a set of one or more people, and third information related to the evaluee different from the first information. The analytics module 308 may be configured to execute instructions, by the processor, to perform analytics to determine a second result associated with a second behavior outcome of the evaluee relative to the set of one or more people, based on at least the third information related to the evaluee that is different from the first information. The analytics module 308 may use a regression technique, a machine learning algorithm, or the like, or a combination thereof. The analytics performed by the analytics module 308 may generate a result (also referred to as an analytics result) associated with a behavior outcome of an evaluee. The behavior outcome with which the analytics result is associated may be the same as or different from the behavior outcome with which the assessment result is associated.

The analytics module 308 may use several sources or categories of data or input to improve the validity and/or reliability of predictions than produced by evaluator-administered risk assessment tools, and to monitor a change in the risk related to an evaluee over time, including between risk assessment sessions. Such improved risk assessment and monitoring may allow timely intervention to reduce the risk related to the evaluee. For instance, the analytics module 308 may be configured to provide predictions on likelihood, frequency, severity, imminence, and a likely victim of future adverse behavior outcomes of an evaluee. The analytics module may generate real time (e.g., hourly, daily, weekly, monthly, or yearly) reports based on risk assessment tool findings derived by the evaluator but also making use of other sources of information that may allow the analytics module 308 to dynamically evaluate risk with respect to the evaluee. The risk assessment system 102 may automatically inform designated people or entities when a threshold (e.g., a preset) is crossed so that a timely action and/or intervention may be performed. Data collected and used by the analytics module 308 may comply with HIPAA, data security and privacy, and patient authorization/opt-in regulations and policies at federal, state, and local government levels as well as at the institutional or private practice business levels. Artificial intelligence and machine learning may be used to modify or improve a risk assessment tool by, e.g., adjusting statistical algorithms for a risk assessment tool based on validity information, where available through linking assessment data with external record sources of institutional or community outcomes.

The processing of the one or more sources or categories of data or input by the analytics module 308 (e.g., by the analytics processor 2712 of the analytics module 308) may be based on an analytics profile. A variety of analytics profiles may be available. Examples include, for example, a change in risk over time, a comparison to local norms, a comparison to manual-based norms, a manual-based probabilistic estimate, or the like, or a combination thereof.

A change in risk over time may provide, e.g., a visual display of changes in total scores, item-level scores, and/or categorical final risk judgments to allow for a graphical representation of an increase, a decrease, or a lack of change between multiple administrations of the same risk assessment tool on the same evaluee. Periods of increased risk, decreased risk, or a lack of change in risk may be isolated in the graphic. The magnitude of changes in total scores (or assessment results), item-level scores (e.g., scores for respective items in a coding sheet of a risk assessment tool), and/or categorical final risk judgments (or assessment results) may be quantifiable. The result of the analytics may be presented in the form of, e.g., a report including the visual display and/or notes, text statements, or the like.

A comparison to local norms may provide, e.g., a visual display of the total score and/or risk category of the evaluee in comparison to other persons or a set of one or more people within the same or similar setting (judged according to, e.g., a unique institution/group identification number or identification factor entered upon logging-in) administered the same risk assessment tool. Also displayed may be, e.g., the percentile of the evaluee along with the percentage of persons in the same setting with higher and lower total scores and/or in higher and lower risk categories. The result may be presented in the form of, e.g., a report including the visual display and/or notes, text statements, or the like.

A comparison to manual-based norms may provide, e.g., a visual display of the total score and/or risk category of the evaluee in comparison to other persons or a set of one or more people in the risk assessment tool's normative sample. Also displayed may be the percentile of the evaluee along with the percentage of persons or a set of one or more people in the same or similar setting with higher and lower total scores and/or in higher and lower risk categories. The result may be presented in the form of, e.g., a report including the visual display and/or notes, text statements, or the like.

A manual-based probabilistic estimate may provide, e.g., a visual display generated for a risk assessment tool that uses a statistical algorithm to generate a manual-based probabilistic estimate of the likelihood of a specific outcome within a specific timeframe. A textual statement may be given that provides a probabilistic estimate of the likelihood of the risk assessment tool's outcome of interest within a specific timeframe given the evaluee's total score or final risk judgment (expressed as, e.g., a percentage out of 100%). Merely by way of example, the accompanying visual display may include three levels: (1) the total number of persons in the risk assessment tool's normative sample; (2) the number of persons in the risk assessment tool's normative sample who received the same or similar score as the evaluee but did not go on to engage in the risk assessment tool's outcome of interest within the specific timeframe; (3) the number of persons in the risk assessment tool's normative sample who received the same or similar score as the evaluee and did go on to engage in the risk assessment tool's outcome of interest within the specific timeframe. The result may be presented in the form of, e.g., a report including the visual display and/or notes, text statements, or the like.

The analytics module 308 may include a reliability assessment unit 2702, an information processor 2704, analytics profiles 2706, a compliance unit 2708, an analytics controller 2710, an analytics processor 2712, and an analytics monitoring unit 2714. The input related to the set of one or more people may be retrieved from an analytics database (DB) 316. The compliance unit 2708 may be configured to retrieve rules applicable to the evaluee from the evaluee's profile saved in, e.g., the user information database 312. The analytics monitoring unit 2714 may be configured to monitor information or analytics result(s), as discussed further elsewhere in the present disclosure.

The analytics controller 2710 may be configured to process one or more categories or sources of input. Exemplary categories or sources of input include the assessment information of the evaluee (with respect to whom an analytics is to be performed), the assessment result based on the assessment information of the evaluee, additional information regarding the evaluee, instructions from a user (e.g., an evaluator) to perform the analytics, information regarding a set of one or more people, or the like. The analytics controller 2710 may receive input regarding analytics and decide next actions accordingly.

For example, if there are several assessment reports regarding an evaluee (e.g., from prior risk assessment sessions) accessible by or saved in the risk management system 102 (e.g., saved in the user information database 312), the analytics controller 2710 may direct the reliability assessment unit 2702 to compare a current assessment report with one or more of the several assessment reports from the prior risk assessment sessions. For example, the reliability assessment unit 2702 may assess whether the scores of static risk factors or protective factors (e.g., whether the evaluee has a history of violent convictions, etc.) are consistent across the assessment reports. Variation in static risk/protective factors across the assessment reports may be an indication that there is an error in at least one of the assessment report. As another example, the reliability assessment unit 2702 may assess the variation of the scores different evaluators gave to the same item in different assessment reports of different risk assessment sessions. Variation may indicate that the item at issue is a volatile factor. If the scores are consistent across several of the assessment reports but one, there may be an error in that assessment report, or there may have been an event related to the evaluee which the evaluator may look into. The reliability assessment unit 2702 may provide information regarding inter-rater reliability, i.e. how consistently evaluators have evaluated the evaluee by administering a risk assessment tool.

The analytics module 308 may be in communication with at least one of the assessment module 306, the reporting module 310, the user information database 312, and the analytics database 314. Analytics may be performed offline. The analytics result, as well as other information related to the analytics performed (e.g., a re-visit schedule) may be saved on a local device (e.g., computer, laptop, tablet, etc.) and may be uploaded to the risk management system 102 (e.g., the user information database 312, etc.) or a cloud storage when the local device is connected to, e.g., the Internet. The analytics module 308 may be in direct or indirect communication with other modules, units, etc., or the risk management system 102.

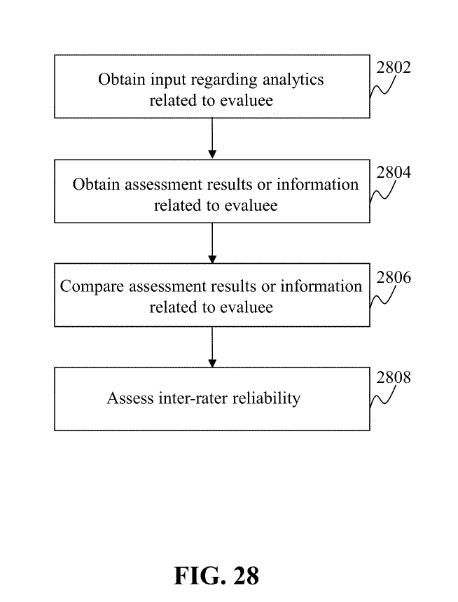

FIG. 28 illustrates a flowchart of an exemplary process of assessing inter-rater reliability according to an embodiment of the present teaching. At 2802, input regarding analytics related to a user (e.g., an evaluee) is received. The input may include assessment information and/or assessment result from a risk assessment session (referred to as a current risk assessment session). The input may include a request to perform an inter-rater reliability analysis. The request may be from a user (e.g., an evaluator), or from the risk assessment system 102 (e.g., when the system 102 detects that there are several assessment reports related to the evaluee from prior risk assessment sessions). At 2804, assessment reports including assessment results or assessment information related to the same evaluee from, e.g., prior risk assessment sessions, are retrieved or obtained. The prior risk assessment sessions may have been administered by the same evaluator or by different evaluators. At 2806, the assessment results and/or information are compared. According to the comparison, the assessment inter-rater reliability is assessed at 2808. The result of the inter-rater reliability assessment from the reliability assessment unit 2702 may be reported to, e.g., the evaluator via, e.g., the reporting module 310. In some embodiments, at least some of the actions described in connection with FIG. 28 may be skipped.

Returning to FIG. 27, if a user (e.g., an evaluator) provides instructions to perform analytics with respect to an evaluee relative to a set of one or more people, the analytics controller 2710 may retrieve an analytics profile from a group of analytics profiles 2706, and information regarding the set of one or more people. The instructions may include information regarding the analytics to be performed, e.g., information regarding which analytics profile to select or retrieve. The selection of an analytics profile may also at least partially depend from information available, e.g., information (e.g., the assessment information, the assessment result, or the like, or a combination thereof) related to the evaluee, information related to the set of one or more people, or the like, or a combination thereof. The set of one or more people may include the evaluee alone. The set may include the evaluee himself and additional people. The set of one or more people may share some characteristics with the evaluee. For instance, the set include one or more people in the same or similar communities, one or more people from the same or similar institutions (e.g., prisons or jails, mental institutions, outpatient clinics, drug treatment centers, half-way houses, hospitals, schools or universities, etc.), workplaces, one or more people with the same or similar family background, diagnostic background, education background, and/or employment background, etc. Information regarding the set of one or more people may be retrieved from, e.g., the analytics database 316. The identities of the set of one or more people may be concealed, at least to the evaluator or evaluee. The information with respect to the set of one or more people may be updated. For instance, there may be new people added to the set if certain criteria are met (e.g., new people admitted to the same hospital as the other people in the set, etc.). As another example, one or more people in the set have shown reduced risk of a violent act over time, the information regarding the set of one or more people may be updated according to the change.

The result of the analytics, also referred to as the analytics result, may be associated with a behavior outcome of the evaluee. The analytics result may include at least one result selected from the group including, e.g., likelihood, frequency, severity, imminence, and a likely victim of the first behavior outcome or the second behavior outcome, or a change thereof. The behavior outcome associated with the analytics result may be the same or different from the behavior out associated with the assessment result. The behavior outcome associated with the analytics result (the second behavior outcome) may be the same as the behavior outcome associated with the assessment result (the first behavior outcome). For instance, both may be a violent action against the evaluee himself, or against a likely victim. The first behavior outcome and the second behavior outcome may be different. For instance, the first behavior outcome may be a violent action by the evaluee, while the second behavior outcome may be, e.g., substance abuse, a behavior related to but different from the first behavior outcome.

The analytics processor 2712 may process one or more categories (or sources) of data (or input) selected from the information (e.g., assessment information) related to the evaluee, a result (e.g., an assessment result) associated with a behavior outcome related to the evaluee based on the information (e.g., the assessment information), the information related to the set of one or more people, or the like, or a combination thereof. Although the assessment information or result related to the evaluee is shown as a separate entry in FIG. 27, it may be part of the input regarding the analytics, as already discussed. Applicable information may relate to, e.g., a criminal history, a sociodemographic characteristic, a clinical characteristic, a physiological or biological characteristic, a sociological characteristic, a behavioral characteristic, or a psychological characteristic, or a change thereof, of the evaluee or the set of one or more people. Applicable information may relate to exemplary factors or characteristics applicable in the analytics similar to those described above in the context of risk assessment.

The analytics processor 2712 may process additional information related to evaluee other than that from a risk assessment session (e.g., assessment information, an assessment result, etc.). The additional information may relate to a criminal history, a sociodemographic characteristic, a clinical characteristic, a physiological or biological characteristic, a sociological characteristic, a behavioral characteristic, or a psychological characteristic, or a change thereof, of the evaluee, similar to those described above in the context of the risk assessment. The additional information may include self-reported data provided by the evaluee via a downloadable mobile application that may be installed on devices such as a smartphone (e.g., iPhone), a tablet (e.g., iPad), a wearable device (e.g., eyeglasses (e.g., Google Glass), smartwatch, glucose meter), or the like. The input from a mobile application may include, e.g., GPS/location information (e.g., proximity to a likely victim such as an ex-wife), physiological or biological information (e.g., a history of head injury (with or without loss of consciousness), corticosteroid levels, heart rate, blood pressure, length and/or quality of sleep, blood platelet count, genomic markers of behavioral risk, amount of exercise, cholesterol level), and psychosocial information (e.g., level of anger). Merely by way of example, the input from a mobile application or another source may provide (direct or circumferential) information related to whether an evaluee adheres to a schedule to take a prescription or refill his prescription. As another example, the input from a mobile application or another source may provide (direct or circumferential) information related to whether the evaluee adheres to a schedule to participate in, e.g., a rehabilitation program, a training program, a community service program, a re-assessment visit, etc.

Some of the additional information may be gathered automatically (e.g., GPS/location information), and/or may automatically update or synchronize with electronic equipment such as a scale, a smartwatch, an activity monitor, a GPS, or the like. Some of the additional information may be supplied by the evaluee (e.g., level of anger, self-perceived level of risk, feedback/satisfaction after risk assessment tool administered by evaluator) or a collateral informant (e.g., an institution (e.g., a hospital, a prison, a mental institution, a school or university, a workplace, etc.), a professional or employee associated with the institution, a caseworker (or social worker) associated with the evaluee, police or a police officer, a family member, a friend, a likely victim, an employer, a colleague, or other people or parties that are associated with or related to the evaluee or interested in risk management with respect to the evaluee, or the like. The risk management system 102, or the analytics module 308, may accept different input at different intervals including, e.g., periodically, from time to time, or in real-time. As an example, if the evaluator identifies the address of a “likely victim,” and the evaluee GPS data shows the evaluee approaches that location or increased frequency of approaching that location, then the risk management system 102 may automatically generate alerts to the evaluee and other designated people or entities (e.g., an institution (e.g., a hospital, a prison, a mental institution, a school or university, a workplace, etc.), a professional or employee associated with the institution, a caseworker (or social worker) associated with the evaluee, police or a police officer, a community liaison, a family member, a friend, a likely victim, an employer, a colleague, or other people or parties that are associated with or related to the evaluee or interested in risk management with respect to the evaluee, or the like). The additional information may include social media data derived from the evaluee's postings on various websites. The additional information may include event-driven data from public and/or proprietary databases. Merely by way of example, the additional information include or come from institutional infraction reports, attendance in therapeutic activities, evaluee-approved supply of biometric data through the use of personal smart devices and access to electronic health records, prescription adherence platforms, unemployment benefit recipient database, gun purchase databases, criminal record databases, or the like, or a combination thereof.

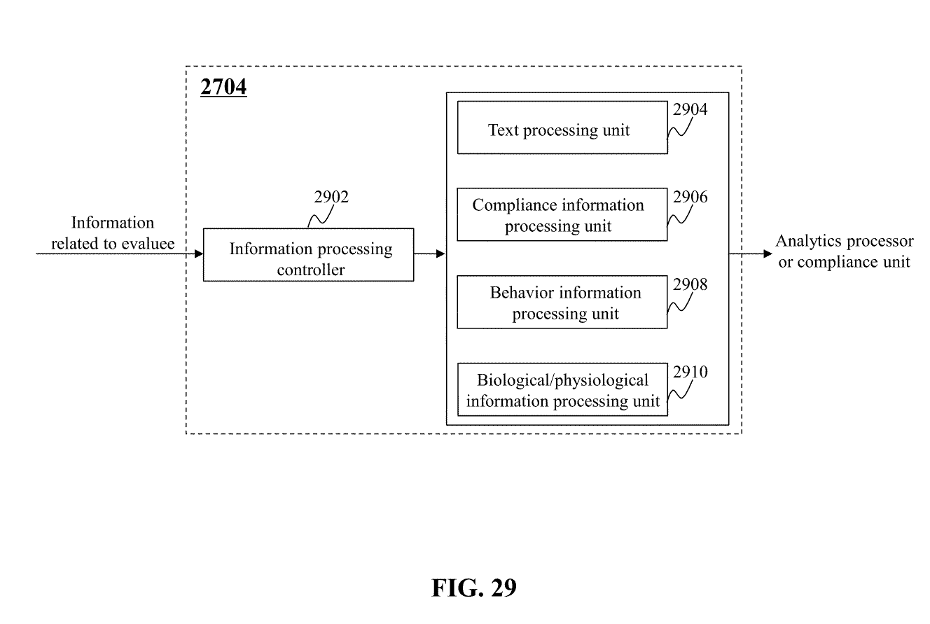

The information processor 2704 may be configured to process various information related to the evaluee, including the additional information other than that from a risk assessment session (e.g., assessment information, an assessment result, etc.). FIG. 29 illustrates an exemplary diagram of an information processor in the analytics module according to an embodiment of the present teaching. The information processor 2704 may include an information processing controller 2902, a text processing unit 2904, a compliance information processing unit 2906, a behavior information processing unit 2908, and a physiological/biological information processing unit 2910. The information processing controller 2902 may be configured to process the received information regarding an evaluee, parse it to different portions if applicable, and forward the portions of the information to various processing units 2904-2910.

The text processing unit 2904 may be configured to process information from social media data derived from the evaluee's postings on various websites. The text processing unit 2904 may perform, e.g., keyword-driven textual analysis and may identify whether there is a change (e.g., increase, or decrease) in the risk of the outcome of interest (e.g., behavioral outcome).

The compliance information processing unit 2906 may be configured to process information related to whether an evaluee complies with one or more rules. Exemplary rules include a prescription; a refill schedule; a schedule for visiting a healthcare provider, a parole officer, or a social worker; a schedule for participating in a rehabilitation program, training program, or community service; or the like, or a combination thereof. Compliance information may be provided by the evaluee himself, detected by a mobile application and reported to the analytics module 308, or reported by a collateral informant. For instance, a mobile device may detect whether an evaluee takes his prescription, and report compliance or non-compliance to the risk management system 102. As another example, if the evaluee fails to refill his prescription, or fails to participate in, e.g., a rehabilitation program, a training program, a community service program, a re-assessment visit, etc., a pharmacist or a person at relevant program may report to the risk assessment system 102 regarding this non-compliance. Processed compliance information may be forwarded to the compliance unit 2708 where it may be compared with corresponding rules stored in, e.g., the user information database 312.

The behavior information processing unit 2908 may be configured to process information related to behaviors of an evaluee. Behavior information may relate to event-driven information from public and proprietary databases. Exemplary information of this category or source includes firearm purchase, arrest, unemployment claim, change in socio-economic status, timing of prescription fulfillment and refills, new criminal record entries, new institutional infraction entries, being added to a terrorist watchlist, a new traffic violation, a new loan or debt delinquency, a new academic disciplinary action, a trip plan (indicated by, e.g., the evaluee booking a flight ticket or a hotel room, a record that the evaluee leaving or entering a country, etc.), a new immigration status change, new loss of security clearance, or new loss of institutional privilege level, or the like. Behavior information may include, e.g., the evaluee's GPS data (e.g., data showing the evaluee approaches a location related to a likely victim), frequency of a behavior (e.g., increased frequency of the evaluee approaching the location related to a likely victim), or the like.

The physiological or phsiological information processing unit 2910 may be configured to process physiological or biological (or biometric) information related to an evaluee. Exemplary physiological or biological information to be processed by the biological/physiological information processing unit 2910 may include a history of head injury (with or without loss of consciousness), corticosteroid levels, heart rate, blood pressure, length and quality of sleep, blood platelet count, genomic markers of behavioral risk, amount of exercise, length and/or quality of sleep, cholesterol level, or the like. The physiological or biological information may be provided by, e.g., a wearable device (e.g., eyeglasses (e.g., Google Glass), smartwatch, glucose meter), a healthcare provider, the evaluee himself, a person related to the evaluee (e.g., a family member, a friend, etc.), or the like.

Various information may be used in combination to derive further information. Merely by way of example, if an evaluee is detected by a GPS in communication with the risk management system 102 at a location far away from a rehabilitation center where he is supposed to participate in a session at the time, the GPS information and the compliance rule regarding the rehabilitation session may be used together to derive the information that the evaluee fails to comply with the compliance rule to attend the rehabilitation session. The GPS information, the compliance rule regarding the rehabilitation session, and/or the derived information may be processed by the information processor 2704 and/or the analytics processor 2712.

The information processor 2704 may include other units configured to process other types of information, e.g., psychological information, etc. The information process 2704, or the units therein including, e.g., 2904, 2906, 2908, and 2910, may process relevant information to a format usable by the analytics processor 2712. Merely by way of example, the information process 2704, or the units therein including, e.g., 2904, 2906, 2908, and 2910, may process relevant information to generate a score for a category of information that may be further processed by the analytics processor 2712.

The analytics monitoring unit 2714 may be configured to monitor information, analytics result(s), or the like, or a combination thereof. For example, the analytics monitoring unit 2714 may compare the information (including, e.g., information or input used in analytics performed with respect to an evaluee) or the analytics result with a threshold, or with previous information or analytics result(s) of, e.g., the same evaluee or a set of one or more people; based on the comparison, the analytics monitoring unit 2714 may make a determination regarding whether to take actions, e.g., providing a report or an alert related to the information, the analytics result, or a change thereof, or any recommendations (e.g., intervention recommendations, etc.), or the like, or a combination thereof.

This is understood that the analytics module 308 may be part of the risk management system 102, or may operate as a stand-alone system that interfaces with other modules or part of the risk management system 102 or the risk management application, as needed.

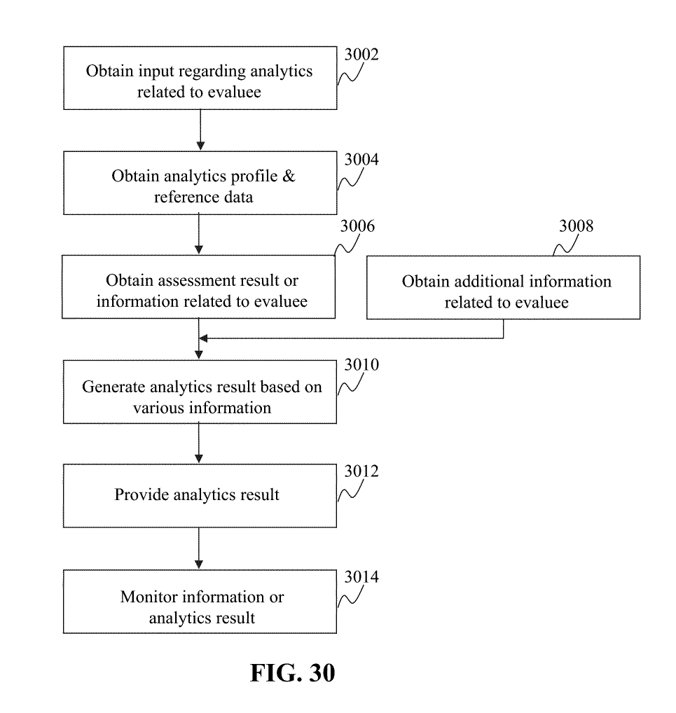

FIG. 30 illustrates a flowchart of an exemplary process of performing an analytics with respect to an evaluee relative to a set of one or more people according to an embodiment of the present teaching. The set may include the evaluee himself. The set may include the evaluee himself and additional people. The set of one or more people may share some characteristics with the evaluee. At 3002, input regarding the analytics related to an evaluee is obtained. The input may include instructions from a user (e.g., an evaluator) regarding the specific type of analytics to be performed. Based on the input, an analytics profile and reference data with respect to the set of one or more people is obtained at 3004. In some embodiments, assessment information and/or the assessment result with respect to the evaluee is obtained at 3006. In some embodiments, the assessment information and/or the assessment result with respect to the evaluee is obtained along with or as part of the input at 3002. The assessment result may be generated based on the assessment information acquired in a risk assessment session by, e.g., the evaluator. In some embodiments, additional information related to the evaluee is obtained at 3008. The reference data related to the set of one or more people, the assessment information related to the evaluee, or the additional information related to the evaluee may relate to, e.g., a criminal history, a sociodemographic characteristic, a clinical characteristic, a physiological or biological characteristic, a sociological characteristic, a behavioral characteristic, or a psychological characteristic, or a change thereof, of the evaluee or the set of one or more people, respectively. Based on at least some of the various information obtained at 3002, 3004, 3006, and 3008, an analytics result is generated at 3010 and provided at 3012. In some embodiments, information (including, e.g., information or input used in analytics performed with respect to an evaluee) or the analytics result may be monitored at 3014. For instance, the information or the analytics result may be compared with a threshold, or with previous information or analytics result(s) of, e.g., the same evaluee or a set of one or more people; based on the comparison, a determination may be made regarding whether to take actions, e.g., providing a report or an alert related to the information, the analytics result, or a change thereof, or any recommendations (e.g., intervention recommendations, etc.), or the like, or a combination thereof. In some embodiments, at least some of the actions described in connection with FIG. 30 may be skipped. Merely by way of example, the monitoring at 3014 may be skipped.

The analytics module 308 may be configured to identify one or more dominant static and/or dynamic risk factors and/or protective factors with respect to the evaluee. As used herein, a dominant risk factor or a protective factor with respect to the evaluee may be one with respect to which the risk assessment result associated with a behavior outcome of the evaluee is sensitive. That is, a small change in the dominant risk factor may cause a significant change in the result associated with a behavior outcome of the evaluee. Likewise, a small change in the dominant protective factor may cause a significant change in the result associated with a behavior outcome of the evaluee. For instance, an evaluee had a substance abuse problem, and was in a rehabilitation program. A pre-mature termination of the rehabilitation program may lead to the evaluee having a relapse (behavior outcome, or outcome of interest in the case). Accordingly, in the case with the specific evaluee, whether the evaluee completes the rehabilitation program may be a dominant risk factor and/or a protective factor.

The analytics result (or a portion thereof) from the analytics module 308 may be provided in the form of, e.g., a report, alone or with notes (provided by the evaluator or the evaluee), or with the assessment result (or a portion thereof) from the risk assessment tool. The report may also include identified dominant static and/or dynamic risk factor(s) and/or protective factor(s). The analytics result, as well as identified dominant static and/or dynamic risk factor(s) and/or protective factor(s), may be saved in the evaluee's profile in the user information database 312.

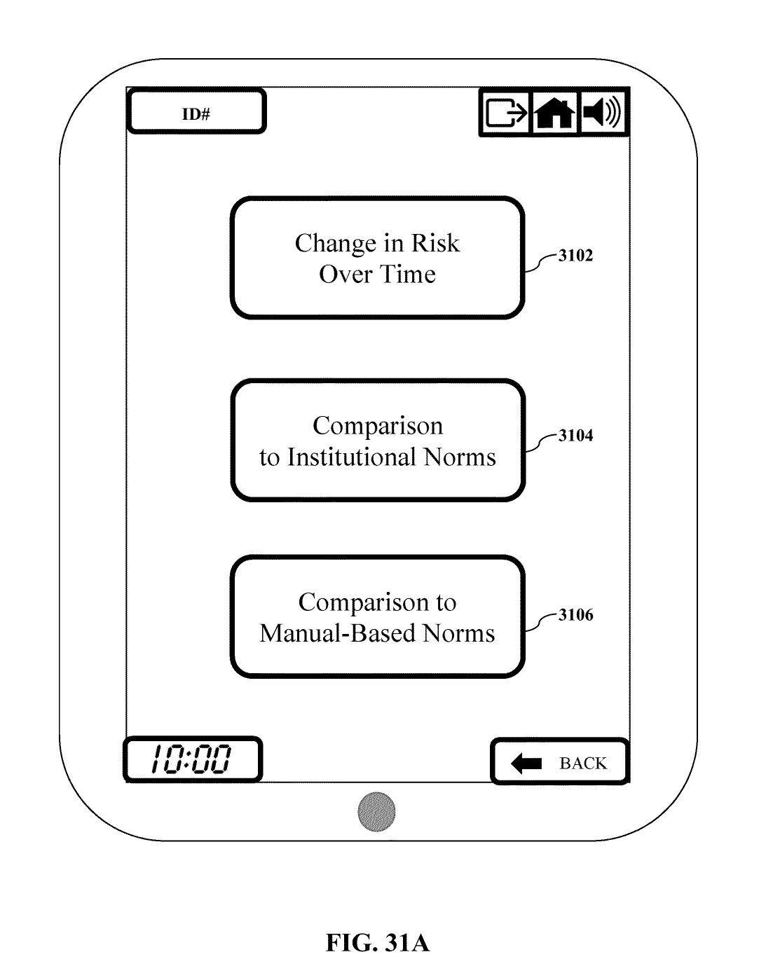

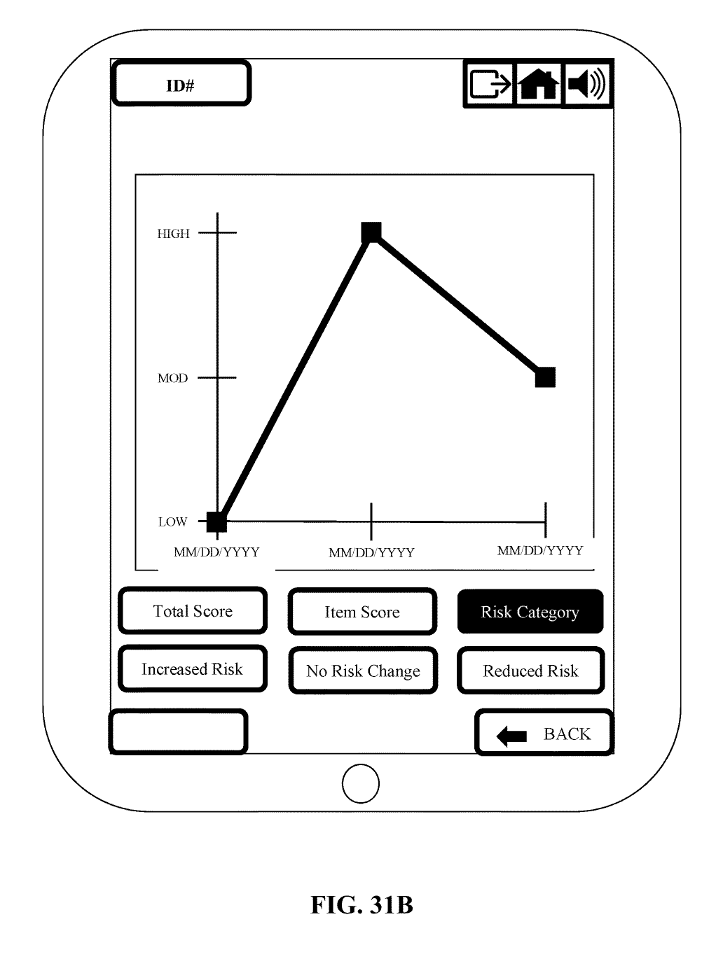

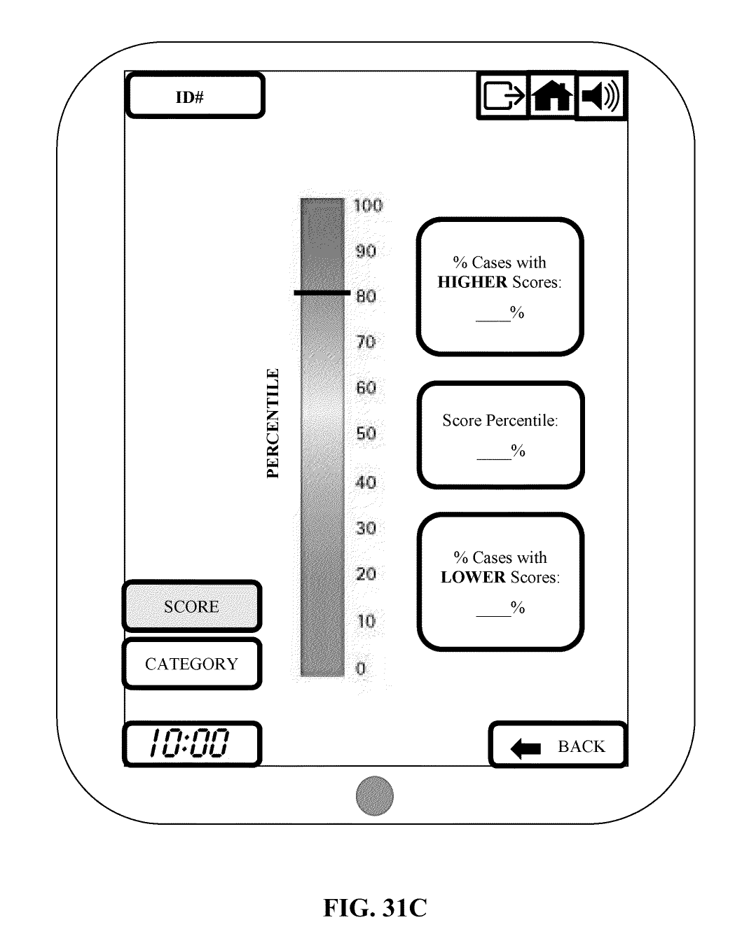

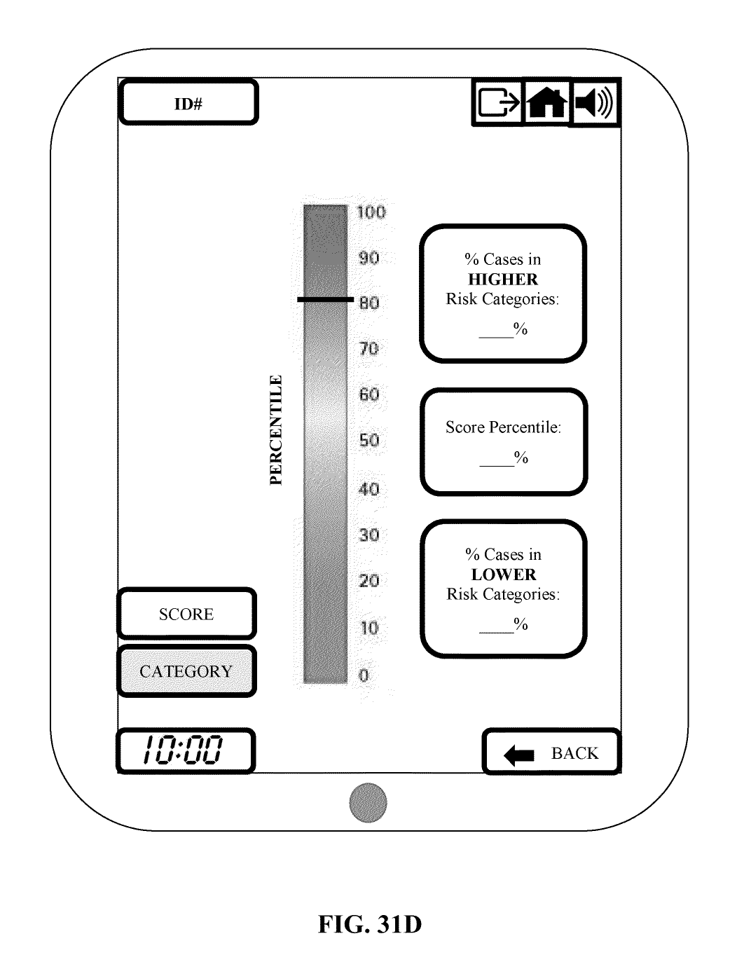

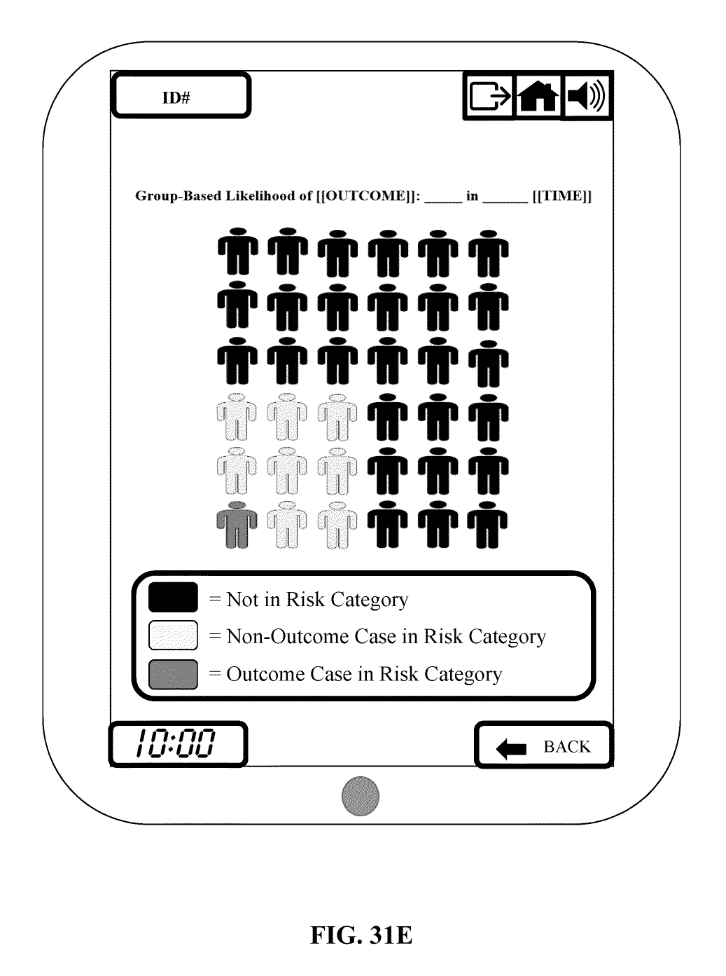

FIG. 31A illustrates a page providing exemplary types of analytics that may be performed in a risk management system according to an embodiment of the present teaching. As illustrated, exemplary types include analytics regarding a change in risk over time 3102, an analytics regarding a comparison to institutional norms 3104, and analytics regarding a comparison to manual-based norms 3106. These exemplary types of analytics are provided for illustration purposes, and not limiting. For instance, the risk management system may allow a user, e.g., an institute user, to define and use a type of analytics applicable to that user; the page illustrated in FIG. 31A may include an additional icon, e.g., “Comparison to Other Norms,” to provide such an option.

FIGS. 31B-31E show the exemplary analytics results. FIG. 31B shows results of “Change in Risk Over Time.” The results may allow the evaluator to visually track increases, decreases, or a lack of change in total scores, item-level scores, or risk category/bin (depending on whether a structured professional judgment tool or actuarial was administered). The x-axis of the graphical figure may be the dates that risk assessments were conducted, whereas the y-axis shows the scores or categories/bins, the result of the respective risk assessments. The evaluator may also isolate periods of increased risk, reduced risk, or where there was no change in risk. The magnitude of changes in total scores, item-level scores, and/or categorical final risk judgments may be quantifiable. The result may be presented in the form of, e.g., a report including the visual display and/or notes, text statements, or the like.

FIG. 31C shows the results of “Comparison to Institutional Norms.” The results may allow the evaluator to visually detect where both the total score as well as the risk category/bin of the evaluee lies compared to other individuals evaluated using the same risk assessment tool in the same institution (or treatment group or region or country or globally). The score percentile of the evaluee along with the percentage of cases with higher total scores and the percentage of cases with lower total scores may be displayed on this page (and are graphically displayed using a thermometer-like image).

FIG. 31D displays the same information as on FIG. 31C except that the information in FIG. 31D focuses on categories/bins (e.g., Low Risk, Moderate Risk, or High Risk) rather than total score.

FIG. 31E shows the results of “Comparison to Manual-Based Norms.” This may be an option if a risk assessment tool following, e.g., the actuarial approach to risk assessment had been administered. The outcome rates used for the graphic on this page may come from the administered tool's manual, which may provide group-based probabilistic estimates of the outcome of interest (also referred to as behavior outcome) within a specific time period. This page may graphically display the number of individuals with different scores or not in the same bin as the evaluee (e.g. 27 people in the example illustrated in the figure), the number of individuals with the same score or in the same bin who are predicted not to engage in the outcome of interest, e.g., within the specified time period (e.g. 8 people in the example illustrated in the figure), and the number of individuals with the same score or in the same bin who are predicted to engage in the outcome of interest, e.g., within the specified time period (e.g. 1 person in the example illustrated in the figure).

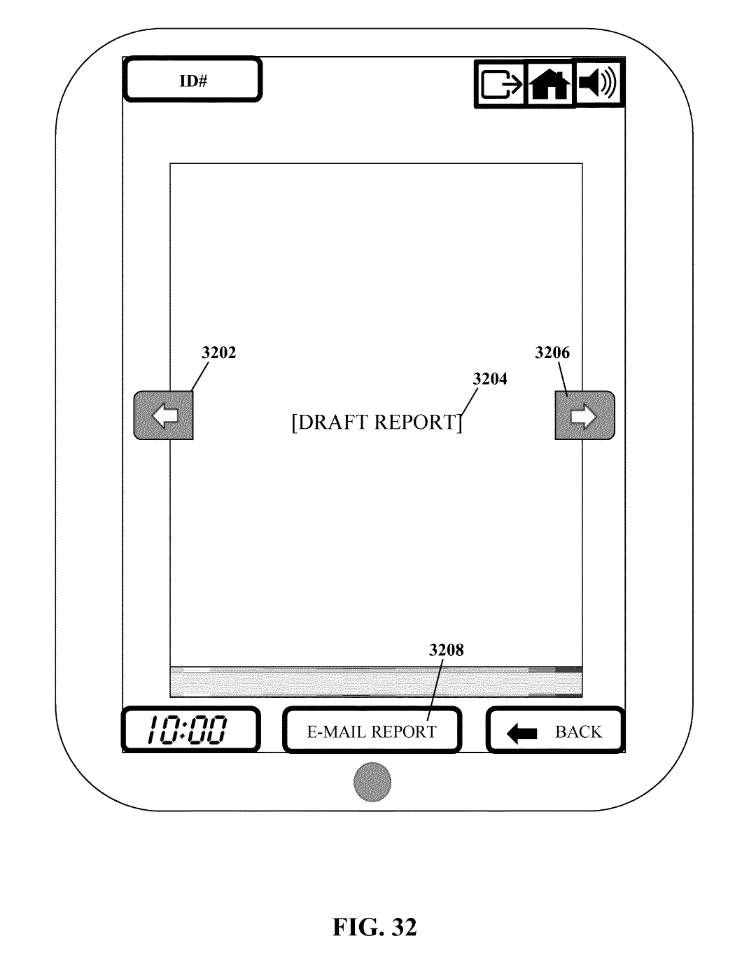

FIG. 32 illustrates a page regarding preparation of a report in a risk management application that constitutes a user interface of a risk management system according to an embodiment of the present teaching. The analytics result (or a portion thereof) from the analytics module 308 may be provided in the form of, e.g., a report. As illustrated in FIG. 32, a user (e.g., the evaluator) may request that a report be prepared by clicking on the “DRAFT REPORT” icon 3204. The user may go back to a previous page by clicking the back arrow 3202, or go to a next page by clicking the forward arrow 3206. By going back and forth this way, the user may review different pages of the report, and specify different features of the report. Merely by way of example, the user may add notes to the report or a part of the report. The notes may be available to be retrieved from the risk assessment system 102 (e.g., saved in the manual regarding an analytics or a risk assessment tool, or the like), or may be written by the user specifically for the analytics or the risk assessment performed for the evaluee. The user may specify how the report should be delivered, e.g., by email by clicking on the “E-MAIL REPORT” icon 3208, or by another way (e.g., by mail, by facsimile, by providing a link to the report to a recipient of the report, or the like).

Any one of the pages illustrated in FIGS. 31A-32 may include other content including, e.g., time, duration of a session (in which a user is logged in the application or has been working on a case with, e.g., an evaluee), time remaining in the session, a logo of a related entity (e.g., the provider of the application or risk management system 102), identity (e.g., in the form of identification factor) of the institution and/or the user (e.g., evaluee or evaluator), an icon indicating whether the device on which the application is being administered is muted or not (the icon may be clickable to mute or un-mute the device), an icon that is clickable to allow a user to go back to a previous page, the home page, or exit the application, a link to the terms or conditions of use, or the like, or a combination thereof.

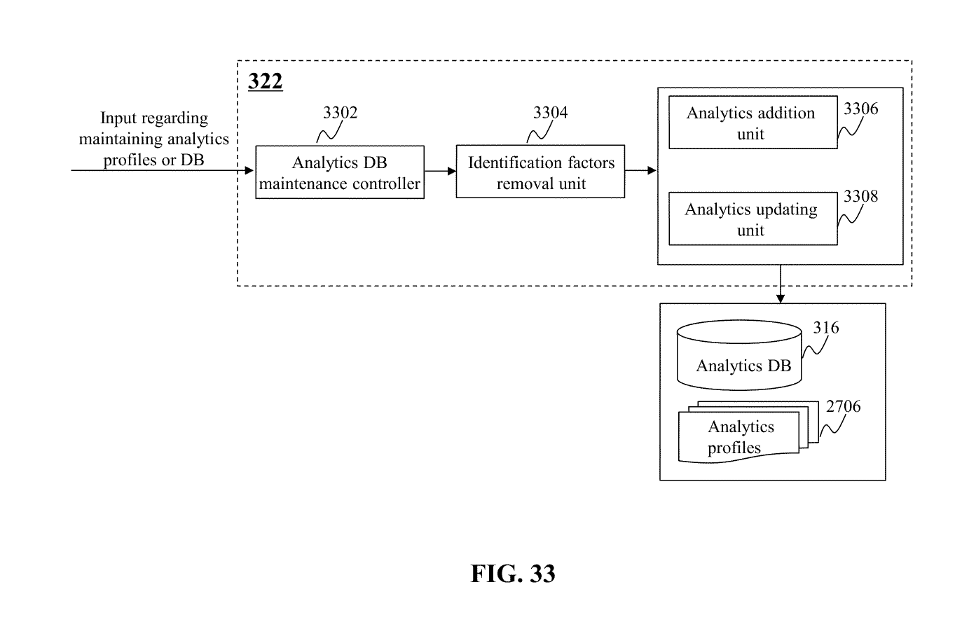

FIG. 33 illustrates an exemplary diagram of an analytics database maintenance module according to an embodiment of the present teaching. The analytics database maintenance module 322 may be configured to maintain the analytics database 316 based on, e.g., an analytics result related to a user, information with respect to other people (e.g., one or more people in the same or similar communities, one or more people from the same or similar institutions (e.g., prisons or jails, mental institutions, outpatient clinics, drug treatment centers, half-way houses, hospitals, schools or universities, etc.), workplaces, one or more people with the same or similar family background, diagnostic background, education background, and/or employment background, etc.). Such information with respect to other people may be used as reference data in an analytics related to a user. The maintenance may be achieved by allowing information regarding a set of one or more people already in the analytics database 316 to be updated, or by allowing new information regarding a new set of one or more people to be added to the analytics database 316, or the like. The maintenance may be performed by, e.g., a tool developer, or by the risk management system 102.

The analytics database maintenance module 322 may include an analytics database (DB) maintenance controller 3302, an identification factor removal unit 3304, an analytics addition unit 3306, and an analytics updating unit 3308. The analytics database maintenance controller 3302 may be configured to determine one or more actions to be performed based on input regarding analytics database maintenance provided by a user, e.g., a tool developer, or by the risk management system 102. The maintenance may be triggered by, e.g., an event occurred with respect to a user (i.e., as a new data point for the user himself or for the set of one or more people the user belonging to). The maintenance may be triggered by, e.g., new information related to a new set of one or more people (e.g., from a hospital, prison, school, workplace, etc., that was not in the risk management system 102) and/or a new analytics profile that has become available.

For instance, if new information or a new analytics profile is to be added into the analytics database 316, the analytics database maintenance controller 3302 may determine one or more actions to be performed by the analytics addition unit 3306. The one or more actions may include, e.g., saving the new information or the new analytics profile in the analytics database 316 or the analytics profiles 2706, indexing the new information or the new analytics profile (e.g., in. alphabetical order and/or based on category), etc. As another example, if information already in the analytics database 316 is to be updated, the analytics database maintenance controller 3302 may determine one or more actions to be performed by the analytics updating unit 3308. The one or more actions may include, e.g., replacing the old information with the new information. Although shown as separate components in FIG. 33 (and also in FIG. 27), the analytics profiles 2706 may be part of the analytics database 316.

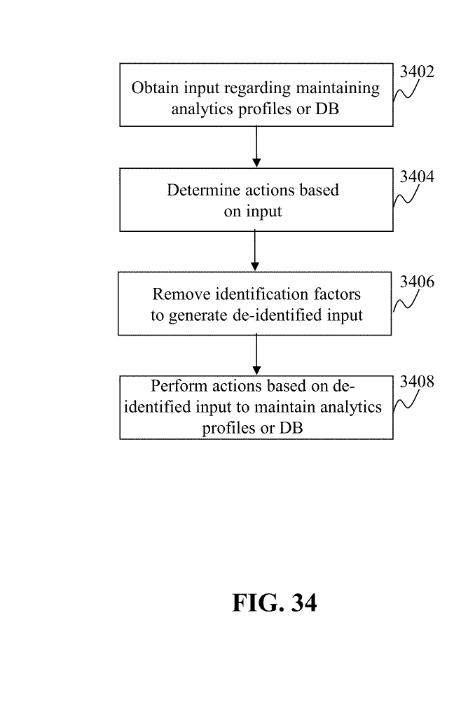

FIG. 34 illustrates a flowchart of an exemplary process of maintaining an analytics database 316 according to an embodiment of the present teaching. At 3402, input regarding maintaining the analytics profiles 2706 or the analytics database 316 is obtained. Based on at least part of the input, a determination is made at 3404 regarding one or more actions to be performed. At 3406, at least part of the input is processed to remove or conceal the identities or identification factors of the people who information is included the input. De-identified input is generated. At 3408, the one or more actions are performed to maintain the analytics profiles 2706 or the analytics database 316. In some embodiments, at least some of the actions described in connection with FIG. 34 may be skipped.

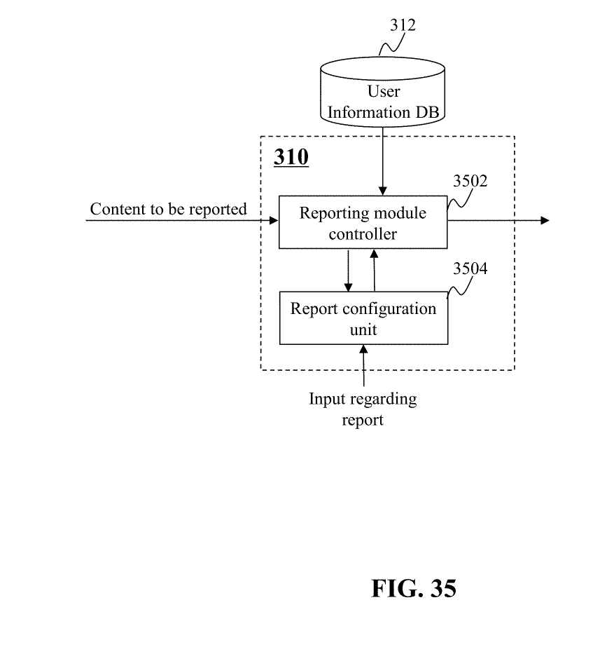

FIG. 35 illustrates an exemplary diagram of a reporting module according to an embodiment of the present teaching. The reporting module 310 may be configured to provide a report based on an assessment result or a change thereof, or an analytics result or a change thereof.

Exemplary content of the report are as follows. The report may include assessment information and the assessment result based on the assessment information, an analytics result, or a change thereof. The report may include a list of evidence-based recommendations (also referred to as an intervention recommendation) regarding interventions that may be generated from the research literature based on the risk assessment or analytics performed with respect to the evaluee, e.g., based on identified dominant risk factors and/or protective factors of the evaluee. The intervention recommendation in the report may also include providers, e.g., local providers, who may perform the recommended intervention(s). If an evaluee is assessed by multiple evaluators, inter-rater reliability may be assessed, and the result may be provided in a report to the evaluators involved. In addition to assessing risk, the amenability of the evaluee for risk management interventions may also be measured and reported. Moreover, the reporting module 310 may generate an alert to be sent to various people and/or institutions when there is a triggering event related to an evaluee. A triggering event may be that the evaluee fails to take his prescription, fails to refill his prescription, approaches a likely victim with a frequency exceeding a threshold, the evaluee's blood pressure or heart rate exceeds a threshold, the evaluee misses a certain number of appointments with his psychiatrist, social worker, or the like, or a combination thereof.

A report may be provided to the evaluee, one or more evaluators, an institution (hospital, prison, workplace, school, etc.), caseworker, associated with the evaluee, police, a community liaison, a tool developer who develops or is interested in developing a risk assessment tool, a family member of the evaluee, a friend, a likely victim, or other people or parties that are associated with the evaluee or interested in the risk with respect to the evaluee (e.g., an employer, a colleague), or the like. Alternatively, different people or entities may get different portions of the report. Still further, the identity information with respect to the evaluee may be removed or concealed, and the report or a part of the report may be provided to a database or entity that compiles such information for institutions, subsets of populations, or the like. For example, when behavior outcome information is collected after risk assessment were made with groups of evaluees, predictive validity estimates may be calculated for groups of evaluees. A database of de-identified data may be created for the purposes of future research and big data analysis.

The reporting module 310 may include a reporting module controller 3502, and a report configuration unit 3504. Content to be reported may be forwarded to the reporting module controller 3502. A report may be compiled. The compilation may include selecting which part of the content to be include in a report, how to present the selected content (e.g., graphically, using text, or the like, or a combination thereof). A delivery method may be selected. Exemplary delivery methods include by email, by facsimile, by providing a link to the report, by phone, by text message, by voice mail, or the like, or a combination thereof. In some embodiments, the compilation or the delivery method may be based on, e.g., a relevant rule saved in the user information database 312. For instance, a user may provide the relevant rule to specify the preferred compilation or delivery method via the signup module 318. Such rule remains effective until the user changes it via the signup module 318. In some embodiments, an intended recipient may specify the compilation or the delivery method for a report before it is generated or sent. Merely by way of example, the intended recipient is allowed, via a “dashboard” (a user interface), to select which part of the content to be included in the report, how the selected content is to presented, how the report is to be delivered, or the like. The report configuration unit 3504 may receive such input provided by the user, and provide instructions to the reporting module controller 3502 such that the reporting module controller 3502 may compile the content for delivery accordingly.

The reporting module 310 may be in communication with at least one of the assessment module 306, the analytics module 308, the user information database 312, and the analytics database maintenance module 322. The reporting module 310 may be in direct or indirect communication with other modules, units, etc., or the risk management system 102.

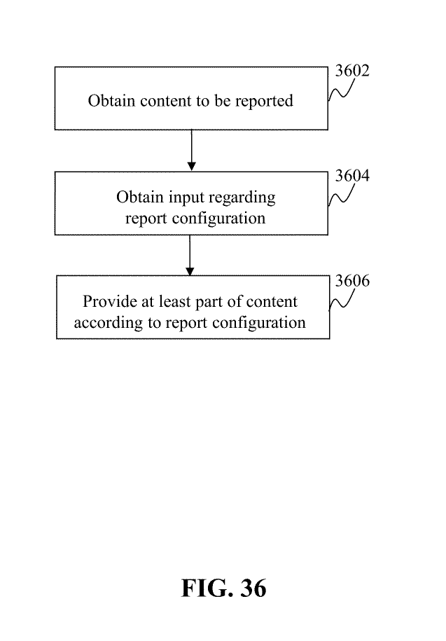

FIG. 36 illustrates a flowchart of an exemplary reporting process according to an embodiment of the present teaching. At 3602, content to be processed for reporting is obtained. At 3604, input regarding report configuration is obtained. The input may be obtained from the user information database 312. The input may be provided by a user (recipient) via, e.g., a “dashboard” (a user interface). At 3606, the content is compiled and provided for reporting according to the report configuration. In some embodiments, at least some of the actions described in connection with FIG. 36 may be skipped.

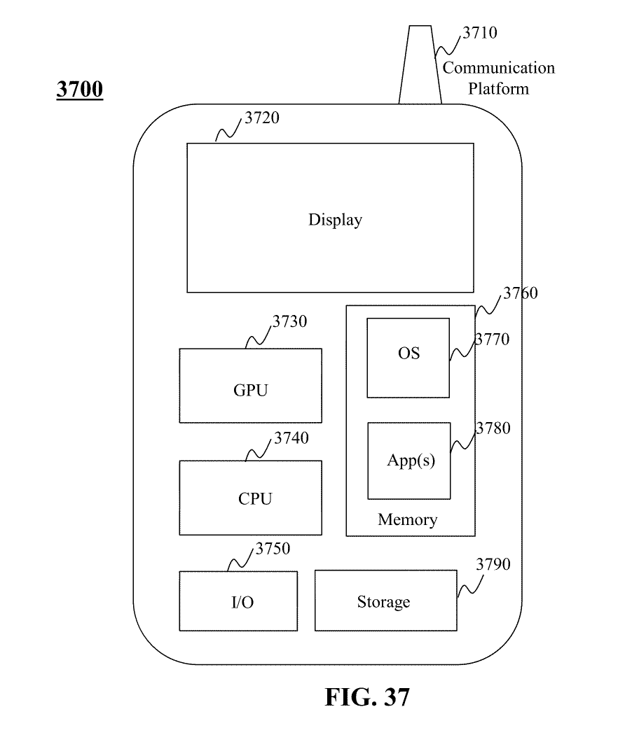

FIG. 37 depicts the architecture of a mobile device which can be used to realize a specialized system implementing the present teaching. In this example, the user device on which a risk management application or other contents are presented and interacted-with is a mobile device 3700, including, but is not limited to, a mobile phone, a tablet computer, a personal computer, a smartphone, a gaming device, a networking device, or a wearable computing device in the form of a wrist watch, a bracelet, a pair of headphones, a pair of eyeglasses and/or other wearable computing devices. The mobile device 3700 in this example includes one or more central processing units (CPUs) 3740, one or more graphic processing units (GPUs) 3730, a display 3720, a memory 3760, a communication platform 3710, such as a wireless communication module, storage 3790, and one or more input/output (I/O) devices 3750. Any other suitable component, including but not limited to a system bus or a controller (not shown), may also be included in the mobile device 3700. As shown in FIG. 37, a mobile operating system 3770, e.g., iOS, Android, Windows Phone, etc., and one or more applications 3780 may be loaded into the memory 3760 from the storage 3790 in order to be executed by the CPU 3740. The applications 3780 may include a browser or any other suitable mobile apps for receiving and rendering content streams on the mobile device 3700. User interactions with the content streams may be achieved via the I/O devices 3750 and provided to the risk management system 102 and/or other components of the networked environment 100/200, e.g., via the network 112.

To implement various modules, units, and their functionalities described in the present teaching, computer hardware platforms may be used as the hardware platform(s) for one or more of the elements described herein (e.g., the risk management system 102 and/or other components of the networked environment 100/200 described with respect to FIGS. 1-36). The hardware elements, operating systems and programming languages of such computers are conventional in nature, and it is presumed that those skilled in the art are adequately familiar therewith to adapt those technologies for risk management as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

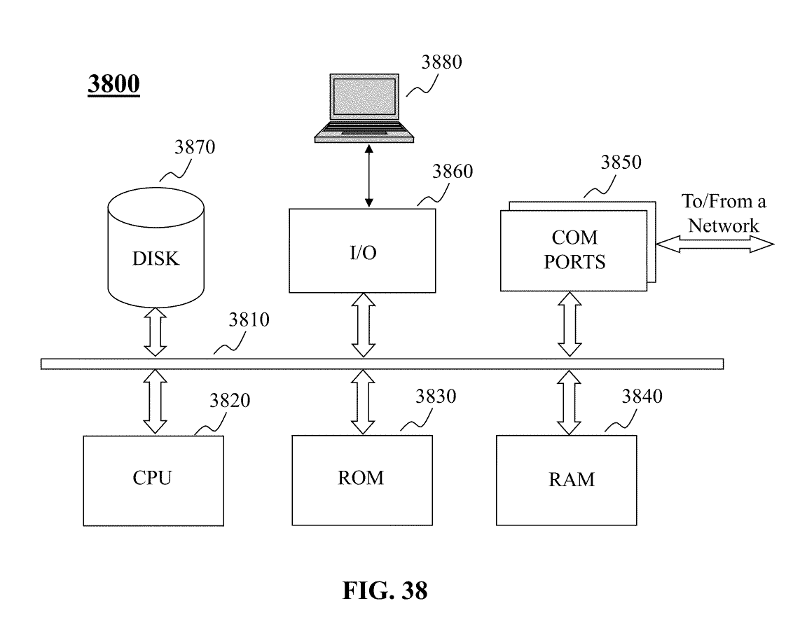

FIG. 38 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 3800 may be used to implement any component of the risk management techniques, as described herein. For example, the risk management system 102 or a part thereof, etc., may be implemented on a computer such as computer 3800, via its hardware, software program, firmware, or a combination thereof. Although only one such computer is shown, for convenience, the computer functions relating to risk management as described herein may be implemented in a distributed fashion on a number of similar platforms, to distribute the processing load.

The computer 3800, for example, includes COM ports 3850 connected to and from a network connected thereto to facilitate data communications. The computer 3800 also includes a central processing unit (CPU) 3820, in the form of one or more processors, for executing program instructions. The exemplary computer platform includes an internal communication bus 3810, program storage and data storage of different forms, e.g., disk 3870, read only memory (ROM) 3830, or random access memory (RAM) 3840, for various data files to be processed and/or communicated by the computer, as well as possibly program instructions to be executed by the CPU. The computer 3800 also includes an I/O component 3860, supporting input/output flows between the computer and other components therein such as user interface elements 3880. The computer 3800 may also receive programming and data via network communications.

Hence, aspects of the methods of risk management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a risk management system or a part thereof into the hardware platform(s) of a computing environment or other system implementing a computing environment or similar functionalities in connection with risk management. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Computer program code for carrying out operations for aspects of the present teaching may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments.

### EXAMPLES

In order that the invention disclosed herein may be more efficiently understood, examples are provided below. It should be understood that these examples are for illustrative purposes only and are not to be construed as limiting the invention in any manner.

### Example 1

George is a 30-year-old man who has been admitted to the psychiatric ward of Hays Hospital for an evaluation of violence risk. Police were called to George's apartment after a neighbor complained of hearing him screaming violent threats at his television. When interviewed by police, George stated that people on his favorite television program have been making disapproving comments about him and talking behind his back for over a year. George is convinced that the characters have been spying on him and that they are able to hear what he is thinking. He has lost his drive to participate in his usual work and family activities and has been spending most of his day locked in his room. George complains that he has been hearing voices even though no one else is around, and these voices tell him what to do and what to think.

A is a staff psychologist working in the psychiatric ward who is tasked with evaluating George's risk of violence towards others in his community. A is uncertain which risk assessment tool to administer to aid in this process. A sits in an evaluation room with a tablet computer as George enters the room and sits across from A at A's desk. Installed on the tablet is a risk management application disclosed herein. As George's medical, court, and police records that have been supplied show no sign of his having been previously hospitalized or arrested, he does not have an identification number (or referred to as identification factor) assigned to him.

### Use of Risk Management System During the Evaluation

1: Launch the risk management application (as illustrated in FIG. 4) and select language.

2: On the Login Page, select New Case (as illustrated in FIG. 7).

3: On the “New Case” page, enter George's demographic characteristics, biometric information, criminal history, and medical history. Submit this information and George is assigned an identification number, which may be classified under the Hays Hospital.

4: If A selects “Contact Us” by, e.g., clicking on the “Contract Us” icon 1108 on the screen illustrated in FIG. 11, A may make note of the address, phone, fax, and e-mail information to be able to contact the provider of the risk management application in the event A has a question when conducting George's risk assessment.

5: A selects, by clicking on the “Conduct an Assessment” icon 1104 on the screen illustrated in FIG. 11, to begin the process of evaluating George's risk of violence towards others.

6: On the screen providing types of risk assessment tools as illustrated in FIG. 14, A selects “Violence Risk Assessment” by clicking on the icon 1402, as this is the outcome of which A is interested in evaluating the risk related to George.

7: On the screen illustrated in FIG. 15, A elects to use the tool selection wizard by clicking on the “Tool Selection Wizard” icon 1502, as A is uncertain which risk assessment tool to administer. A follows the inquiries provided by the tool selection wizard to ensure that the risk assessment tools it suggests are intended for George's age (30 year old adult), population (psychiatric patient), and the outcome of interest (community).

8: A examines the suggested risk assessment tools produced by the tool selection wizard organized in the Tool Library of uploaded risk assessment tools. A views each risk assessment tool's intended population, outcome, the number of items to be administered, item content domains, and administration time, and selects the risk assessment tool with an appropriate or best goodness-of-fit for George in the current context. This information may be updated as new versions of risk assessment tools are published or as additional risk assessment tools are added to the risk management system or the tool library.

9: A elects to participate in a tool training session by, e.g., viewing a video tutorial and completing a sample case study in order to practice using the risk assessment tool. An assessment of A's preparedness as well as evaluee preparedness can be conducted here.

10: A elects to view an electronic version of the risk assessment tool's manual.

11: A elects to open a new coding sheet to open a blank coding sheet for the risk assessment tool.

12: Fill out the blank coding sheet for the risk assessment tool following the instructions from the tool manual and using the skills developed in the tool training session. For static items, the responses to which may be derived from the information entered on the “New Case” page, responses may be auto-filled. A can look-up the scoring criteria for specific items from the electronic version of the risk assessment tool's manual. A may take notes concerning specific items that may be stored with the responses on the coding sheet. A may specify the timeframe for which the risk assessment is intended to apply. A may predict the imminence of any anticipated violence. A may predict the severity of any anticipated violence.

A may predict the frequency of any anticipated violence. A may predict the likely victim of an anticipated violence. A may clinically override the findings of the risk assessment tool.

13: A may set a reminder to re-assess George on a date on the screen illustrated in FIG. 23. A may provide an e-signature and submit the coding sheet on the screen illustrated in FIG. 24.

14: A may calibrate one or more electronic devices to transmit, receive, and integrate self-report, social media, and event-driven data related to George. The risk management system or risk management application is capable of accepting and integrating input from a wide variety of external sources (e.g., institutional infraction reports, attendance in therapeutic activities, evaluee-approved supply of biometric data through the use of personal smart devices and access to electronic health records, global positioning system (GPS) location data, prescription adherence platforms, unemployment benefit recipient database, social media, gun purchase databases, criminal record databases, etc.).

15: A elects to perform an analytics by clicking on the “Analytics” icon 2602 on the screen illustrated in FIG. 26. A elects, by clicking on the “Comparison to Institutional Norms” icon 3104 in the screen illustrated in FIG. 31, to compare George's score percentile to other individuals in Hays Hospital or the geographic region in which the hospital is located. This percentile information may include the percentage of other individuals with higher or lower scores in Hays Hospital or the geographic region in which the hospital is located. If the risk assessment tool administered has produced a categorical output rather than a numerical probabilistic output, percentile information may be based on the percentage of other individuals in higher or lower risk categories in Hays Hospital or the geographic region in which the hospital is located. These norms (also referred to as reference data) may be up dated periodically, from time to time, or in real-time as additional assessments are conducted at Hays Hospital or the geographical region in which the hospital is located.

16: A elects, by clicking on the “Comparison to Manual-Based Norms” 3106 in the screen illustrated in FIG. 31, to compare George's score percentile to other individuals in the risk assessment tool's normative sample. This percentile information may include the percentage of other individuals with higher or lower scores in the risk assessment tool's normative sample. If the risk assessment tool administered has produced a categorical output rather than a numerical/probabilistic output, this analytic option may be unavailable. These norms (also referred to as reference data) may be updated periodically, from time to time, or in real-time as new norms are published for the selected tool.

17: A elects to perform/view an analytics regarding Manual-Based Probabilistic Estimate in order to view a graphic that accompanies the percentile information provided on the “Comparison to Manual-Based Norms” screen. This graphic may depict the number of individuals in the total normative sample for the risk assessment tool and identify the number of false positives and true positives relative to George's score. If the risk assessment tool administered has produced a categorical output rather than a numerical/probabilistic output, this analytic option may be unavailable. These estimates may be updated periodically, from time to time, or in real-time as new norms are published for the selected risk assessment tool.

18: A selects “Draft Report” on the screen illustrated in FIG. 32 to view a comprehensive report generated using the information entered for George in the blank coding sheet. As part of this report, a list of recently published peer-reviewed research on the risk assessment tool may be included as well as a list of evidence-based “best practice” interventions and local treatment providers who offer these interventions. A elects to e-mail the report to himself and/or the relevant case authority by clicking on the “E-MAIL REPORT” icon 3208 on the screen illustrated in FIG. 32.

19: Logout of George's case.

20: Exit the risk management application.

### Use of Risk Management System after the Evaluation

The decision is made to discharge George to the community under A's supervision. Using the calibration settings established in item 14 regarding George's case, the risk management application monitors George's violence risk in real-time and sends an alert to relevant authorities when the following is found to occur in the month after his discharge:

George registers a new handgun

George files for unemployment benefits

George changes his social media accounts such that his relationship status is updated from “in a relationship” to “single”

George's pill dispenser electronically identifies that he has stopped taking his prescribed medication

George's fitness device electronically identifies that he has not been sleeping

George's GPS electronically identifies that he travels past his ex-wife's home once daily, despite a restraining order

George's self-assessed level of anger as measured via text messages automatically sent to his smartphone daily raise by 50%

Based on this additional information, A, as well as the local police department, may be notified such that risk management procedures or interventions may be put into place to prevent possible adverse behavior.

### Example 2

Paul is a 40-year-old man incarcerated in Birk Prison who has recently become eligible for parole following 10 years served for a conviction of aggravated assault. Each year, Paul's general recidivism risk has been assessed using the same risk assessment tool. These assessments are administered on a laptop computer using a risk management application as disclosed herein.

B is Paul's case manager, a social worker employed at the prison in which he is incarcerated. The warden has requested that B assesses Paul's recidivism risk again in anticipation of his appearance before the parole board. Paul's medical, court, and police records that have been supplied and have listed his Identification Number (or identification factor). B started this assessment earlier in the day and is now ready to complete it.

### Use of Software During the Evaluation

1: Launch the risk management application (as illustrated in FIG. 4) and select language.

2: On the Login Page, B enters Paul's existing identification number (or identification factor), as well as the identification number (or identification factor) for Birk Prison.

3: B elects, by clicking the “Case Information” icon 1102 on the screen illustrated in FIG. 11, to review logged case information to remind himself of Paul's demographic characteristics, biometric information, criminal history, and medical history. If any of this information needs to be modified, B makes these changes.

4: B elects, by clicking the “Archived Assessment Reports” icon 1106 on the screen illustrated in FIG. 11, to review archived assessment reports to remind himself of which risk assessment tools have been administered to Paul in the past and/or how recently.

5: B selects, by clicking the “Conduct an Assessment” icon 1104 on the screen illustrated in FIG. 11, in order to continue the process of evaluating Paul's recidivism risk assessment.

6: On the screen providing types of risk assessment tools as illustrated in FIG. 14, B selects “General Recidivism Risk Assessment” by clicking the icon 1406, as this is the outcome of which B is interested in evaluating the risk related to Paul.

7: On the screen illustrated in FIG. 15, B selects to manually select the risk assessment tool by clicking the “Select My Own Tool” icon 1504, as B knows which risk assessment tool to continue administering.

8: Select the risk assessment tool you want to continue administering from the tool library of uploaded risk assessment tools. This information may be updated as new versions of risk assessment tools are published or as additional risk assessment tools are added to the risk management system or the tool library.

9: On the screen illustrated in FIG. 21, B views a list of archived coding sheets including both completed and uncompleted coding sheets for the selected risk assessment tool.

10: Select the Uncompleted Coding Sheet for the risk assessment tool that B started to fill out earlier in the day.

Alternatively, on the screen illustrated in FIG. 21, there are archived coding sheets, based on risk assessment tool administrated for Paul at different times, and/or different risk assessment tools administered for Paul. B may open the coding sheet to be completed in order to continue the risk assessment with Paul, and skips items 6-8 regarding Paul's case.

11: B finishes filling out the uncompleted coding sheet for the risk assessment tool. For static items, the responses to which may be derived from the information entered on the “New Case” page, responses may be auto-filled. B may look-up the scoring criteria for specific items from the electronic version of the risk assessment tool's manual. B may take notes concerning specific items that may be stored with the responses on the coding sheet. B may specify the timeframe for which the risk assessment is intended to apply. B may predict the imminence of any anticipated violence. B may predict the severity of any anticipated violence. B may predict the frequency of any anticipated violence. B may predict the likely victim of any anticipated violence. B may clinically override the findings of the risk assessment tool.

12: B may set a reminder to re-assess Paul on a date on the screen illustrated in FIG. 23. B may provide an e-signature and submit the coding sheet on the screen illustrated in FIG. 24.

13: B may calibrate one or more electronic devices to transmit, receive, and integrate self-report, social media, and event-driven data related to Paul. The risk management system or risk management application is capable of accepting and integrating input from a wide variety of sources external to the risk management system or risk management application. External sources include, e.g., institutional infraction reports, attendance in therapeutic activities, evaluee-approved supply of biometric data through the use of personal smart devices and access to electronic health records, global positioning system (GPS) location data, prescription adherence platforms, unemployment benefit recipient database, social media, gun purchase databases, criminal record databases, etc. While many of these input choices may be inapplicable or irrelevant while Paul is incarcerated, they may become applicable or relevant after his parole is granted.

14: B elects to perform an analytics by clicking on the “Analytics” icon 2602 on the screen illustrated in FIG. 26. B elects, by clicking on the “Change in Risk Over Time” icon 3102 on the screen illustrated in FIG. 31, to compare Paul's total and item scores across the three administrations of the risk assessment tool. If the risk assessment tool administered has produced a categorical output rather than or in addition to a numerical probabilistic output, comparison information may be based on categories. Increases, decreases, and no changes in scores and/or categories are able to be isolated. Changes at the level of the individual, group, or geographic region are also able to be isolated.

15: B elects, by clicking on the “Comparison to Institutional Norms” icon 3104 on the screen illustrated in FIG. 31, to compare Paul's score percentile to other individuals in Birk Prison or the geographic region in which the prison is located. This percentile information may include the percentage of other individuals with higher or lower scores in Birk Prison or the geographic region in which the prison is located. If the risk assessment tool administered has produced a categorical output rather than or in addition to a numerical probabilistic output, percentile information may be based on the percentage of other prison in higher or lower risk categories in Birk Prison or the geographic region in which the prison is located. These norms may be updated periodically, from time to time, or in real-time, as additional assessments are conducted at Birk Prison or the geographical region in which the prison is located.

16: B elects, by clicking on the “Comparison to Manual-Based Norms” icon 3106 on the screen illustrated in FIG. 31, to compare Paul's score percentile to other individuals in the risk assessment tool's normative sample. This percentile information may include the percentage of other individuals with higher or lower scores in the risk assessment tool's normative sample. If the risk assessment tool administered has only produced a categorical output rather than a numerical/probabilistic output, this analytic option may be unavailable. These norms may be updated periodically, from time to time, or in real-time as new norms are published for the selected risk assessment tool.

17: B elects to perform or view an analytics regarding Manual-Based Probabilistic Estimate in order to view a graphic to accompany the percentile information provided on the “Comparison to Manual-Based Norms” screen. This graphic may depict the number of individuals in the total normative sample for the risk assessment tool and identify the number of false positives and true positives relative to Paul's score. If the risk assessment tool administered has only produced a categorical output rather than a numerical/probabilistic output, this analytic option may be unavailable. These estimates may be updated periodically, from time to time, in real-time as new norms are published for the selected risk assessment tool.

18: B selects “Draft Report” on the screen illustrated in FIG. 32 to view a comprehensive report generated using the information entered for Paul. As part of this report, a list of recently published peer-reviewed research on the risk assessment tool may be included as well as a list of evidence-based “best practice” interventions and local treatment providers who offer these interventions. B elects to e-mail the report to himself and/or the relevant case authority by clicking on the “E-MAIL REPORT” icon 3208 on the screen illustrated in FIG. 32.

19: Logout of Paul's case.

20: Exit the risk management application.

### Use of Risk Management System after the Evaluation

The decision is made not to grant Paul parole, and he is sent back to general population at Birk Prison. Using the calibration settings established in item 13 regarding Paul's case, the risk management system or risk management application may monitor Paul's recidivism risk in real-time as institutional infraction reports are logged and attendance in therapeutic activities is tracked. No alerts are sent to B, prison administrators, or the parole board, as Paul displays exemplary behavior in the months following his annual recidivism risk assessment.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

These and other objects, features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended as a definition of the limits of the invention. As used in the specification and in the claims, the singular form of “a”, “an”, and “the” include plural referents unless the context clearly dictates otherwise.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the risk management as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A system comprising:
a processor, and an analytics module, and a tool module, wherein the analytics module is configured to;
receive, via an electronic communication platform, at the processor, a first result associated with a first behavior outcome based on first information related to an evaluee input through a user device in communication with the processor, second information related to a set of one or more people stored in a first database in communication with the processor, and third information related to the evaluee different from the first information stored in a second database in communication with the processor, wherein the first result is generated based on a first risk assessment tool selected from an electronic library of one or more risk assessment tools, the electronic library associated with the tool module; and
execute instructions, by the processor, to perform analytics to determine, in real time, a second result associated with a second behavior outcome of the evaluee relative to the set of one or more people, based on at least the third information,
wherein the tool module is configured to execute instructions, by the processor, to change information using a machine learning algorithm in the processor based on at least the first result and/or the second result,
wherein the system is adapted for risk management.

2. The system of claim 1, wherein the analytics module comprises an analytics controller configured to
execute the instructions, by the processor, to select the analytics to be performed based on at least the first result or the second information.

3. The system of claim 2, wherein the analytics module comprises an analytics processor configured to
execute the instructions, by the processor, to perform the selected analytics to determine the second result.

4. The system of claim 1, wherein the first information, the second information, or the third information relates to a criminal history, a sociodemographic characteristic, a clinical characteristic, a physiological or biological characteristic, a sociological characteristic, a behavioral characteristic, or a psychological characteristic, or a change thereof, of the evaluee or the set of one or more people.

5. The system of claim 1, wherein the third information comprises information received via a communication platform from at least one source selected from the group consisting of a posting related to the evaluee on a website, an event related to the evaluee, and a report from the evaluee or from a party associated with the evaluee.

6. The system of claim 1, wherein the analytics module further comprises an information processor configured to
execute the instructions, by the processor, to process the third information,
the information processor including at least one unit selected from the group consisting of a text processing unit, a compliance information processing unit, a behavior information processing unit, and a physiological or biological information processing unit.

7. The system of claim 1, wherein the analytics module further comprises a compliance unit configured to
execute the instructions, by the processor, to determine, based on the third information or a lack of the third information, whether the evaluee complies with a rule related to the evaluee.

8. The system of claim 1, wherein the second result comprises at least one result selected from the group consisting of likelihood, frequency, severity, imminence, and a likely victim of the second behavior outcome, or a change thereof, or an intervention recommendation.

9. The system of claim 1, wherein the analytics module further comprises an analytics monitoring unit configured to
execute the instructions, by the processor, to determine whether the second result or a change of the second result exceeds a threshold; and
mark, if the second result or the change of the second result exceeds the threshold, the second result or the change of the second result for reporting.

10. The system of claim 1 further comprising a tool selection module configured to
execute the instructions, by the processor, to select a risk assessment tool, the risk assessment tool including a set of inquiries related to at least part of the first information.

11. The system of claim 10, wherein the tool selection module comprises a tool selection wizard, a tool library having one or more risk assessment tools, or access to a tool library having one or more risk assessment tools.

12. The system of claim 1 further comprising an assessment module configured to
receive, via a risk assessment tool, the first information, and
execute the instructions, by the processor, to generate, based on the first information in accordance with the risk assessment tool, the first result.

13. The system of claim 12, wherein the assessment module is configured to
execute the instructions, by the processor, to retrieve at least part of the first information from a pre-existing record with respect to the evaluee.

14. The system of claim 12, wherein the risk assessment tool is based on fixed tool reference data.

15. The system of claim 1 further comprising an authentication module configured to:
receive a first identification factor of the evaluee; and
execute the instructions, by the processor, to authenticate the evaluee with respect to the first identification factor.

16. The system of claim 1 further comprising a signup module configured to generate an identification factor.

17. The system of claim 1, wherein the set of one or more people includes the evaluee.

18. A method comprising:
receiving, via an electronic communication platform, at a processor, a first result associated with a first behavior outcome based on first information related to an evaluee input through a user device in communication with the processor, second information related to a set of one or more people stored in a first database in communication with the processor, and third information related to the evaluee different from the first information stored in a second database in communication with the processor, wherein the first result is generated based on a first risk assessment tool selected from an electronic library of one or more risk assessment tools, the electronic library associated with a tool module; and
performing, by the processor, analytics to determine, in real time, a second result associated with a second behavior outcome of the evaluee relative to the set of one or more people, based on at least the third information,
wherein the tool module is configure to execute instructions, by the processor, to change information using a machine learning algorithm in the processor based on at least on the first and/or second result,
wherein the processor is adapted for risk management.

19. The method of claim 18 further comprising:
selecting the analytics to be performed based on at least the first result or the second information.

20. The method of claim 18, wherein the first information, the second information, or the third information relates to a criminal history, a sociodemographic characteristic, a clinical characteristic, a physiological or biological characteristic, a sociological characteristic, a behavioral characteristic, or a psychological characteristic, or a change thereof, of the evaluee or the set.

21. The method of claim 18, wherein the third information comprises information received via a communication platform from at least one source selected from the group consisting of a posting related to the evaluee on a website, an event related to the evaluee, and a report from the evaluee or from a party associated with the evaluee.

22. The method of claim 18 further comprising:
determining, based on the third information or a lack of the third information, whether the evaluee complies with a rule related to the evaluee.

23. The method of claim 18 further comprising:
determining, whether the second result or a change of the second result exceeds a threshold; and
marking, if the second result or the change of the second result exceeds the threshold, the second result or the change of the second result for reporting.

24. The method of claim 18 further comprising:
selecting a risk assessment tool, the risk assessment tool including a set of inquiries related to at least part of the first information.

25. The method of claim 18 further comprising:
receiving, via a risk assessment tool, the first information, and
generating, based on the first information in accordance with the risk assessment tool, the first result.

26. A non-transitory machine-readable tangible medium having instructions recorded thereon, wherein the instructions, when read by the machine, cause the machine to perform actions comprising:
receiving, via an electronic communication platform, a first result associated with a first behavior outcome based on first information related to an evaluee input through a user device in communication with the processor, second information related to a set of one or more people stored in a first database in communication with the processor, and third information related to the evaluee different from the first information stored in a second database in communication with the processor, wherein the first result is generated based on a first risk assessment tool selected from an electronic library of one or more risk assessment tools, the electronic library associated with a tool module; and
performing, by a processor, analytics to determine, in real time, a second result associated with a second behavior outcome of the evaluee relative to the set of one or more people, based on at least the third information,
wherein the tool module is configured to execute instructions, by the processor, to change information using a machine learning algorithm in the processor based on at least on the first and/or second result,
wherein the processor is adapted for risk management.

27. The medium of claim 26, wherein the actions comprise:
determining, based on the third information or a lack of the third information, whether the evaluee complies with a rule related to the evaluee.

28. The medium of claim 26, wherein the actions comprise:
determining whether the second result or a change of the second result exceeds a threshold; and
marking, if the second result or the change of the second result exceeds the threshold, the second result or the change of the second result for reporting.

29. The medium of claim 26, wherein the actions comprise:
selecting a risk assessment tool, the risk assessment tool including a set of inquiries related to at least part of the first information.

30. The medium of claim 26, wherein the actions comprise:
receiving, via a risk assessment tool, the first information, and
generating, based on the first information in accordance with the risk assessment tool, the first result
